(19) United States
(12) Patent Application Publication
(10) Pub. No.: US 2011/0273474 A1
(43) Pub. Date: Nov. 10, 2011

(54) IMAGE DISPLAY APPARATUS AND IMAGE DISPLAY METHOD

(75) Inventor: Naomi IWAYAMA, Kawasaki (JP)

(73) Assignee: FUJITSU LIMITED, Kawasaki (JP)

(21) Appl. No.: 13/188,804

(22) Filed: Jul. 22, 2011

Related U.S. Application Data
(63) Continuation of application No. PCT/JP2009/051530, filed on Jan. 30, 2009.

(51) Int. Cl. G09G 5/00

(52) U.S. Cl. 345/636

(57) ABSTRACT

A PC displaying an image on a display unit accepts handwriting input to the image, and displays the accepted handwriting on the image. The PC detects object regions including a certain object in the image and comment placement regions corresponding to respective object regions. If the starting position of the first stroke of handwriting is included in any one of the object regions, the PC determines that the accepted handwriting is directed to the object region. When the input of the handwriting to the object region is finished, the PC identifies a display region for the handwriting and changes the size of the input handwriting so as to display the input handwriting in the comment placement region corresponding to the object region. The PC displays the size-changed handwriting in the identified display region and further displays a comment balloon surrounding the displayed handwriting.

### CROSS-REFERENCE TO RELATED APPLICATION

This application is a continuation of PCT application PCT/JP2009/051530, filed on Jan. 30, 2009, the entire contents of which are incorporated herein by reference.

### FIELD

The present invention relates to an image display apparatus, an image display method and a computer program.

### BACKGROUND

In recent years, imaging apparatuses, such as a digital still camera and a digital video camera, have become widespread. For instance, various image processes on images taken by the imaging apparatuses using a personal computer have also become widespread. The image processes include not only various conversion processes executed on the image itself but also, for instance, processes of adding a drawing or comment information input by a user to the image. As to the process of adding comment information to the image, a technique has been proposed that detects a face region in an image, establishes a character region in a position that does not overlap with the detected region and adds comment information to the established character region.

[Patent Document 1] Japanese Patent Laid-Open No. 2007-310487

[Patent Document 2] Japanese Patent Laid-Open No. 2007-004677

[Patent Document 3] Japanese Patent Laid-Open No. 2005-159850

Addition of comment information to an image requires, for instance, an operation for designating which person in the image to which the comment information is to be added and an operation for inputting the comment information. Some apparatuses require an operation of setting a mode for adding the comment information to the image. Accordingly, it is required for a user to become familiar with certain operational procedures and perform operations according to the operational procedures. It is thus difficult to improve usability.

### SUMMARY

An image display apparatus disclosed in an embodiment displays an image on a display unit, accepts a handwriting input to the displayed image, and displays the accepted handwriting on the displayed image. The image display apparatus disclosed in the embodiment detects one or more object regions including respective objects included in the image, and displays information indicating the detected object region on the displayed image. The image display apparatus disclosed in the embodiment determines whether the handwriting is directed to any one of the object regions or not on the basis of the accepted handwriting and the detected object regions. In a case of determining that the handwriting is directed to any one of the object regions, the image display apparatus identifies which object region the handwriting is directed to, and further identifies a placement region for placing the handwriting to the identified object region. The image display apparatus calculates a scaling ratio in a scaling process executed on the handwriting for displaying the accepted handwriting in the identified placement region, and executes the scaling process on the handwriting according to the calculated scaling ratio. The image display apparatus extracts a display region for displaying handwriting after the scaling process from the identified placement region, and displays the handwriting after the scaling process on the extracted display region.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a block diagram illustrating an example of a configuration of a PC of Embodiment 1.

FIG. 2 is a schematic diagram illustrating stored contents of a detection region table of Embodiment 1.

FIG. 3 is a functional block diagram illustrating an example of a functional configuration of the PC of Embodiment 1.

FIG. 4 is a functional block diagram illustrating an example of the functional configuration of the PC of Embodiment 1.

FIG. 5 is a schematic diagram for illustrating processes executed by the PC of Embodiment 1.

FIG. 6 is a schematic diagram for illustrating processes executed by the PC of Embodiment 1.

FIG. 7 is a flowchart illustrating procedures of a process of generating the detection region table of Embodiment 1.

FIG. 8 is a flowchart illustrating procedures of processes executed by the PC of Embodiment 1.

FIG. 9 is a flowchart illustrating procedures of processes executed by the PC of Embodiment 1.

FIG. 10 is a flowchart illustrating procedures of a comment process of Embodiment 1.

FIG. 11 is a schematic diagram illustrating a variation of an image to which a comment is added.

FIG. 12 is a schematic diagram illustrating stored contents of a detection region table in Embodiment 2.

FIG. 13 is a schematic diagram for illustrating processes executed by a PC of Embodiment 2.

FIG. 14 is a flowchart illustrating procedures of a process of generating the detection region table of Embodiment 2.

FIG. 15 is a schematic diagram illustrating stored contents of the detection region table of Embodiment 3.

FIG. 16 is a schematic diagram for illustrating processes executed by a PC of Embodiment 3.

FIG. 17 is a flowchart illustrating procedures of processes executed by the PC of Embodiment 3.

FIG. 18 is a flowchart illustrating procedures of processes executed by the PC of Embodiment 3.

FIG. 19 is a flowchart illustrating procedures of processes executed by a PC of Embodiment 4.

FIG. 20 is a flowchart illustrating procedures of processes executed by the PC of Embodiment 4.

FIG. 21 is a functional block diagram illustrating functions provided by a comment processor of Embodiment 5.

FIG. 22 is a flowchart illustrating procedures of a comment process of Embodiment 5.

FIG. 23 is a functional block diagram illustrating functions provided by a comment processor of Embodiment 6.

FIG. 24 is a flowchart illustrating procedures of a comment process of Embodiment 6.

FIG. 25 is a flowchart illustrating procedures of the comment process of Embodiment 6.

FIG. 26 is a schematic diagram illustrating stored contents of a detection region table of Embodiment 7.

FIG. 27 is a schematic diagram for illustrating processes executed by a PC of Embodiment 7.

FIG. 28 is a flowchart illustrating procedures of processes executed by the PC of Embodiment 7.

FIG. 29 is a flowchart illustrating procedures of processes executed by the PC of Embodiment 7.

FIG. 30 is a flowchart illustrating procedures of a comment process of Embodiment 7.

FIG. 31 is a flowchart illustrating procedures of a comment invoking process of Embodiment 7.

FIG. 32 is a block diagram illustrating an example of a configuration of a PC Embodiment 8.

FIG. 33 is a block diagram illustrating an example of a configuration of a PC of Embodiment 9.

### DESCRIPTION OF EMBODIMENTS

For instance, an image display apparatus according to an embodiment detects an object region including a certain object included in an image, and notifies a user of the object region in the image by displaying information representing the detected object region on the displayed image. When the user performs a handwriting input to the image, the image display apparatus detects whether the handwriting is an input of a comment to be added to any one of the objects in the image or not and acquires the comment as a target to be added to any one of the objects in the image. The image display apparatus then identifies an appropriate display region in which the comment input via handwriting by the user to the image is displayed. Further, the image display apparatus applies a scaling process to the input comment to be changed into an appropriate size and subsequently displays the scaled comment on the identified display region.

An image display apparatus, an image display method and a computer program will hereinafter be described in detail with reference to the drawings. Each embodiment where an image display apparatus is applied to a personal computer (hereinafter, referred to as PC) will hereinafter be described. The image display apparatus may be applied to not only a PC but also apparatuses having a function of displaying an image on a display unit and a function of allowing an intuitive operation for an image displayed on the display unit. Such an intuitive operation is included in a touch panel and a pen tablet. More specifically, the image display apparatus can be applied to a digital still camera, a digital video camera, a mobile phone, a PHS (Personal Handy-phone System), a PDA (Personal Digital Assistant) and a mobile game machine.

### Embodiment 1

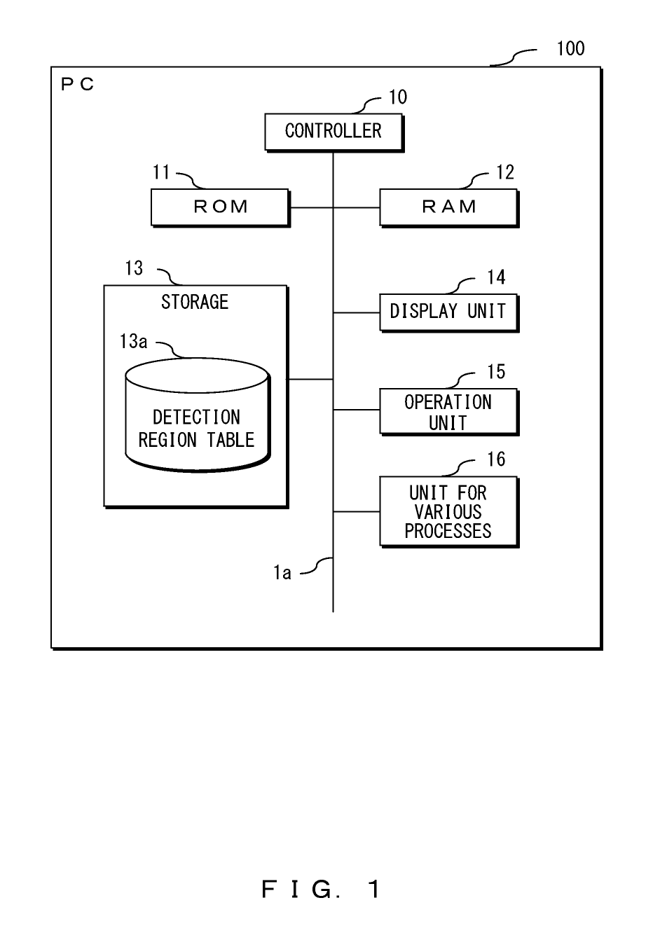

A PC according to Embodiment 1 will hereinafter be described. FIG. 1 is a block diagram illustrating an example of a configuration of the PC of Embodiment 1. A PC 100 of this Embodiment 1 is, for instance, a tablet personal computer. The PC 100 of this Embodiment 1 realizes operations of an image display apparatus by reading a computer program disclosed in an embodiment and causing a CPU (Central Processing Unit) and the like to execute the program. Instead of a general-purpose PC, a dedicated apparatus may realize the image display apparatus.

The PC 100 of this Embodiment 1 includes a controller 10, a ROM (Read Only Memory) 11, a RAM (Random Access Memory) 12, a storage 13, a display unit 14, an operation unit 15, a unit for various processes 16. These hardware units are connected to each other via a bus 1a. The PC 100 of this Embodiment 1 preliminarily stores a computer program in the ROM 11 or the storage 13. The PC 100 realizes the operations of the image display apparatus by causing the controller 10 to execute the computer program.

The controller 10 is a CPU, an MPU (Micro Processor Unit) or the like, and appropriately reads into the RAM 12 control programs preliminarily stored in the ROM 11 or the storage 13, according to a prescribed timing. The controller 10 controls operations of the aforementioned hardware units. The ROM 11 preliminarily stores various control programs used for operations of the PC 100. The RAM 12 is an SRAM, a flash memory or the like, and temporarily stores various pieces of data caused during execution of the control program by the controller 10.

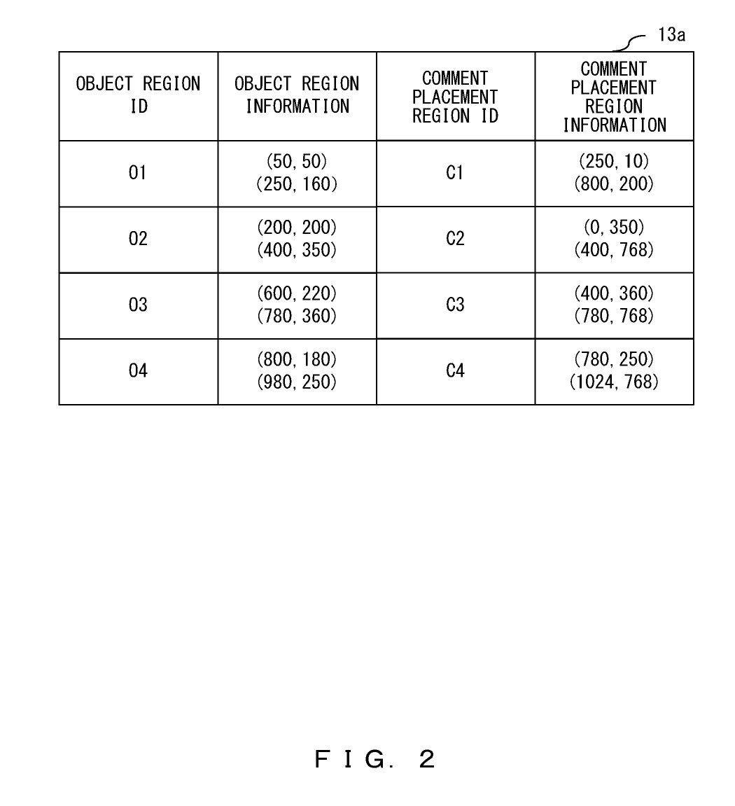

The storage 13 may be a hard disk drive, a flash memory or the like. The storage 13 preliminarily stores various control programs used for operations of the PC 100. The storage 13 stores a detection region table 13a as illustrated in FIG. 2. The details of the detection region table 13a will be described later.

The storage 13 stores image data acquired by imaging by an imaging apparatus, such as a digital still camera, a digital video camera, a camera mobile phone and a camera game machine. In a case where the PC 100 has an imaging function, the image data may be image data acquired by imaging by the PC 100, image data stored in a recording medium, image data received from an external apparatus via a network.

The display unit 14 and the operation unit 15 may configure, for instance, a tablet, a digitizer and the like. More specifically, the display unit 14 is, for instance, a liquid crystal display, and displays an operating status of the PC 100 on a screen, information input via the operation unit 15, information to be notified to a user and the like according to instructions from the controller 10. The display unit 14 also displays operation keys used by the user for operating the PC 100 on a screen.

The operation unit 15 may be, for instance, a stylus pen or a mouse. When the user operates an operation key displayed on the display unit 14 through the operation unit 15, the operation unit 15 transmits a control signal corresponding to the operated operation key to the controller 10. The controller 10 executes a process corresponding to the control signal acquired from the operation unit 15.

The unit for various processes 16 executes various processes according to instructions from the controller 10. The various processes are executable by the PC 100.

FIG. 2 is a schematic diagram illustrating stored contents of the detection region table 13a of Embodiment 1. As illustrated in FIG. 2, the detection region table 13a stores an object region ID, object region information, a comment placement region ID, comment placement region information and the like. The object region ID is an ID for identifying an object region including a certain object detected from an image. The object region information represents each object region and, for instance, represents top left and bottom right points in each object region by coordinate values (x, y) with respect to a prescribed reference point (0, 0).

The reference position (0, 0) is, for instance, the top left point in a region displayable on the display unit 14. The coordinate values (x, y) of the top left and bottom right points in each object region are represented using a right direction as an x coordinate axis and a downward direction as a y coordinate axis from the reference position (0, 0). The top right, bottom left or bottom right points in the region displayable on the display unit 14 may be the reference point (0, 0).

The comment placement region ID is an ID for identifying a comment placement region detected in an image for a certain object. The comment placement region information is information representing a comment placement region detected in the image for the certain object (object region) and, for instance, represents the top left and bottom right points in each comment placement region by coordinate values (x, y) with respect to a prescribed reference point (0, 0).

The object region ID and the object region information stored in the detection region table 13a are stored by the controller 10 every time the controller 10 detects an object in the image. The comment placement region ID and the comment placement region information to be stored in the detection region table 13a are stored by the controller 10 every time the controller 10 detects a comment placement region in the image.

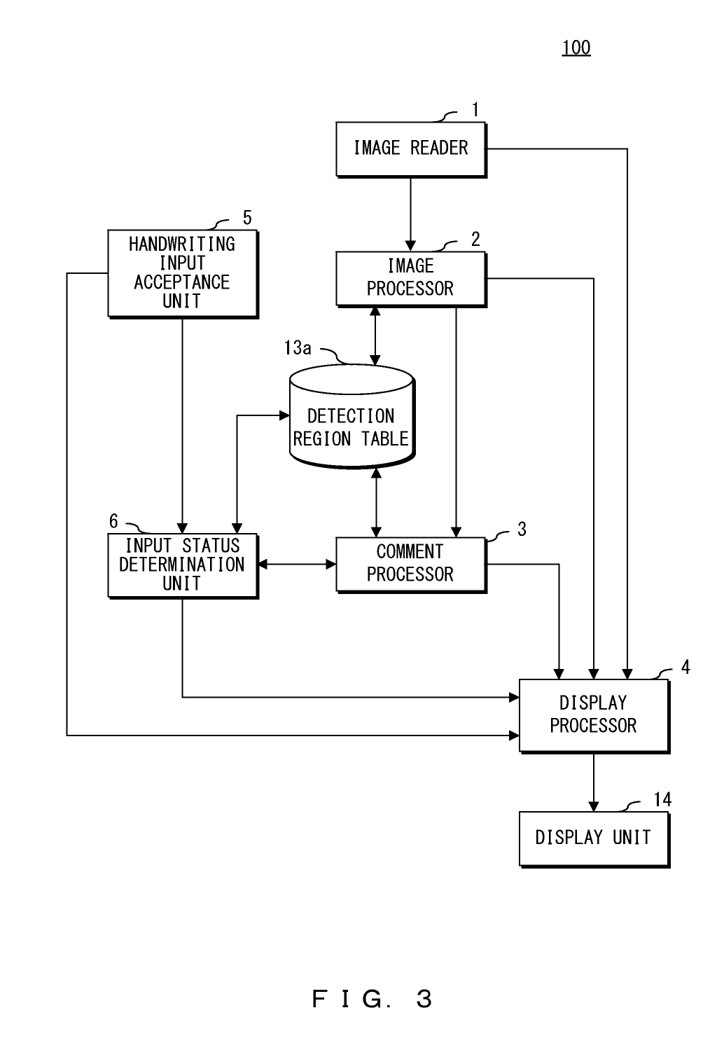

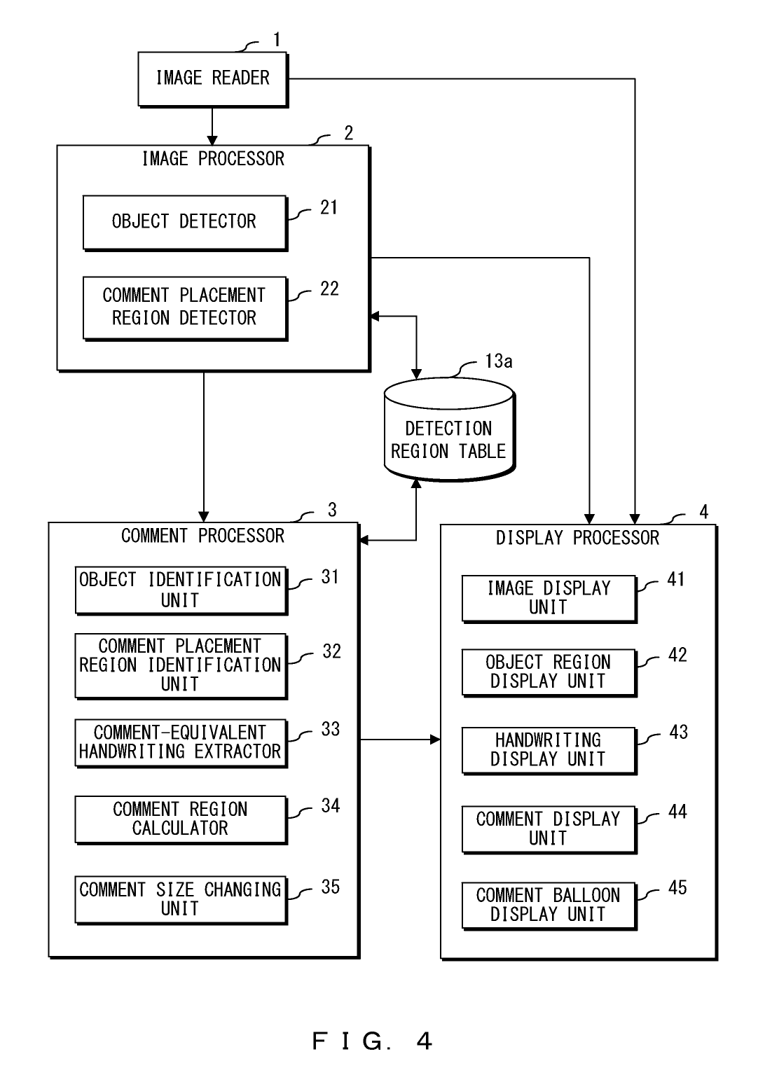

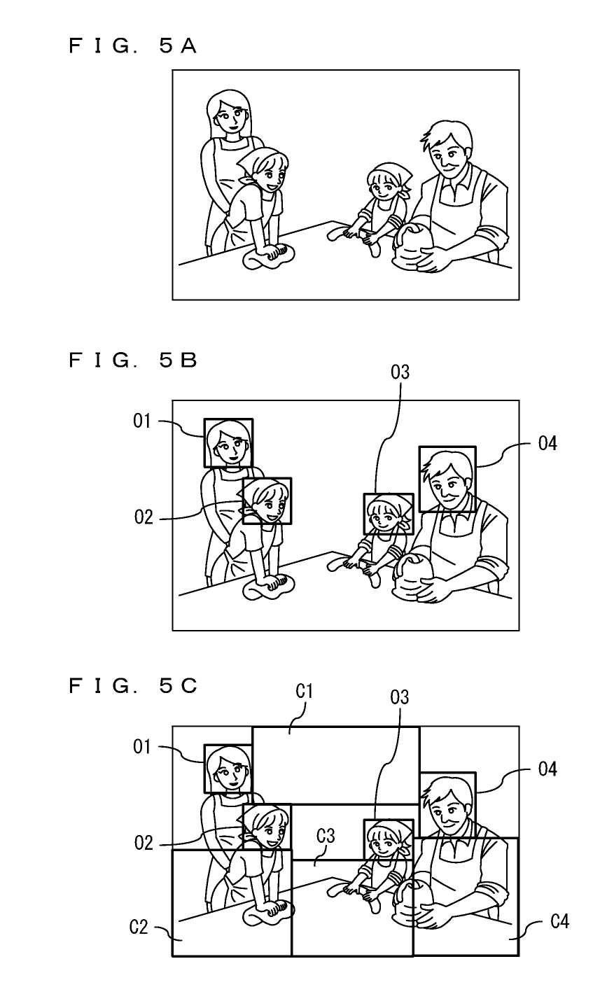

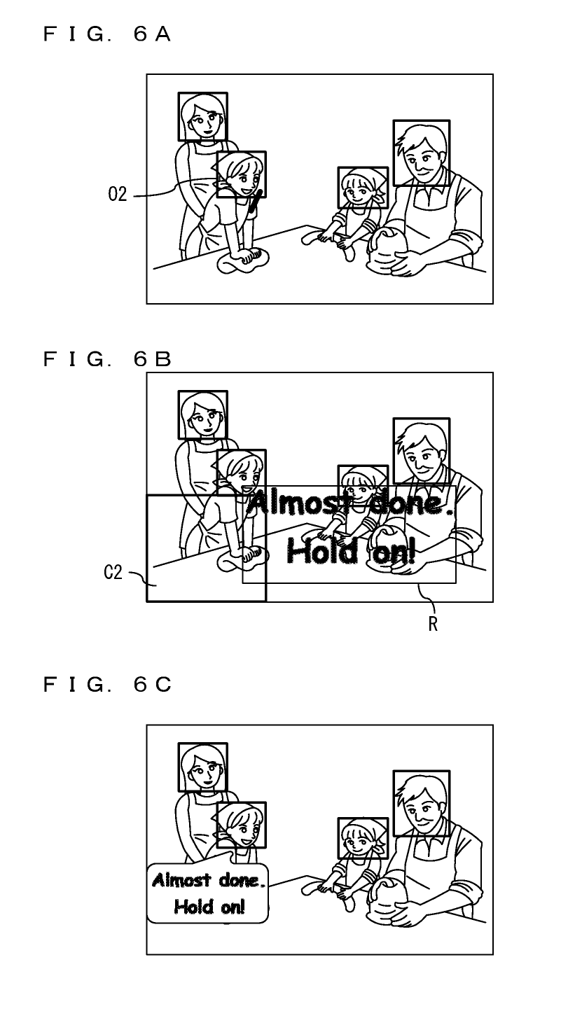

Functions realized by the controller 10 executing the control program stored in the ROM 11 or the storage 13 in the PC 100 of this Embodiment 1 will hereinafter be described. FIGS. 3 and 4 are functional block diagrams each illustrating an example of a functional configuration of the PC 100 of Embodiment 1. FIGS. 5 and 6 are schematic diagrams for illustrating processes executed by the PC 100 of Embodiment 1.

In the PC 100 of this Embodiment 1, the controller 10 realizes functions of an image reader 1, an image processor 2, a comment processor 3, a display processor 4, a handwriting input acceptance unit 5, an input status determination unit 6 and the like by executing the control program stored in the ROM 11 or the storage 13. The image processor 2 has functions of an object detector 21 and a comment placement region detector 22. The comment processor 3 has functions of an object identification unit 31, a comment placement region identification unit 32, a comment-equivalent handwriting extractor 33, a comment region calculator 34 and a comment size changing unit 35. The display processor 4 has functions of an image display unit 41, an object region display unit 42, a handwriting display unit 43, a comment display unit 44 and a comment balloon display unit 45.

When the user of the PC 100 performs a prescribed operation for starting an edit process on an image, the image reader 1 reads image data designated by the user from the storage 13 and transmits the data to the image processor 2 and the display processor 4.

In the display processor 4 having acquired the image data from the image reader 1, the image display unit (image display means) 41 displays an image based on the acquired image data on the display unit 14. FIG. 5 (a) depicts an example of the image displayed on the display unit 14 by the image display unit 41.

In the image processor 2 having acquired the image data from the image reader 1, the object detector (detection unit) 21 detects whether a certain object is taken in the acquired image data or not. For instance, the object detector 21 detects whether the face of a person is taken in the image data or not. If the object detector 21 detects the face of a person, the object detector 21 detects a region including the face. Various methods may be adopted as a method of detecting the face of a person in image data. These methods may be, for instance, a method of detecting a skin-colored region, a method of extracting features of a face including eyes, a mouth, a nose and a contour.

When the object detector 21 detects that the face of a person is taken in the image data, the object detector 21 further detects a rectangular region including the detected face. The object detector 21 assigns the detected face regions (hereinafter, referred to as object regions) with object region IDs O1, O2, . . . , in the order of detection. The object detector 21 stores the coordinate values of the top left and the bottom right of the detected object region as object region information in association with the assigned object region IDs in the detection region table 13a.

Note that the object detector 21 of this Embodiment 1 detects the face region in the image data. However, it is not limited to the face of a person if a contour line is extracted from the image data and a certain shape is identified by the extracted contour line. For instance, a building in image data acquired by imaging a scene or various pieces of furniture in image data acquired by imaging the interior of a room may be detected.

The object detector 21 detects all object regions (face regions) in the image data and stores the object region IDs and the object region information of the detected object regions in the detection region table 13a. After detecting all the object regions, the object detector 21 reads the object region information stored in the detection region table 13a and transmits the read information to the display processor 4.

In the display processor 4 having acquired the object region information from the object detector 21, the object region display unit (object region display means) 42 displays frames surrounding the respective object regions (face regions) on the image displayed on the display unit 14 on the basis of the acquired object region information. FIG. 5 (b) is an example in which the frame surrounding the object region is displayed on the image by the object region display unit 42. FIG. 5 (b) includes the object region IDs assigned to the object regions to identify the respective frames. However, only the frames may be actually displayed on the image on the display unit 14.

The object region display unit 42 may display the frames surrounding the respective object regions after the object detector 21 has finished detecting all the object regions, or the object detector 21 may display the frames surrounding the respective object regions every time the object detector 21 detects an object region. As illustrated in FIG. 5 (b), the object regions may explicitly be indicated by being surrounded with the respective frames. However, it is not limited to the method of surrounding object regions with respective frames if the object regions may explicitly be indicated.

The object detector 21 detects all the object regions in the image data, generates the detection region table 13a and subsequently notifies the comment placement region detector 22 of this generation. When the generation of the detection region table 13a is notified, the comment placement region detector 22 detects a comment placement region with respect to each object region whose object region ID and object region information are stored in the detection region table 13a.

The comment placement region detector (placement region detector) 22 sequentially reads each set of an object region ID and object region information stored in the detection region table 13a, and detects a comment placement region for each object region. The comment placement region detector 22 detects a region that is adjacent to the read object region and does not overlap with another object region or another comment placement region as the comment placement region for this object region on the basis of the read object region information.

When the comment placement region detector 22 detects the comment placement region for each object region, the comment placement region detector 22 assigns thereto a comment placement region ID corresponding to the object region ID. More specifically, the comment placement region detector 22 assigns a comment placement region ID C1 to the comment placement region for the object region having an object region ID O1. The comment placement region detector 22 stores the assigned comment placement region ID and the coordinate values of the top left and the bottom right of the detected comment placement region (comment placement region information) in the detection region table (storing unit) 13a in association with the object region ID and the object region information.

When the comment placement region detector 22 detects a plurality of comment placement regions in one object region, the comment placement region detector 22 selects one comment placement region according to a prescribed condition and then stores information of the selected comment placement region in the detection region table 13a. The prescribed condition is, for instance, that the area is the maximum or that the region is adjacent to the right (or downwardly adjacent) to the object region.

The comment placement region detector 22 detects the comment placement regions for all the object regions for which the object region IDs and the object region information is stored in the detection region table 13a. The comment placement region detector 22 stores the comment placement region ID and the comment placement region information for the detected comment placement region in the detection region table 13a.

FIG. 5 (c) is an example of comment placement regions C1, C2, C3 and C4 detected for the respective object regions O1, O2, O3 and O4 in the image. The comment placement regions C1, C2, C3 and C4 for the respective object regions O1, O2, O3 and O4 are thus set so as not to overlap each other.

As described above, the user performs a handwriting input on the image with the PC 100, in which the image and the frames surrounding the respective object regions are displayed, according to a prescribed rule. More specifically, for instance, in a case where the user wishes to assign comment information to a desired object (here, a person in the image) via handwriting input, the user starts a handwriting input in the frame surrounding the object. In cases other than the case of assigning the comment information to the desired object, it suffices that the user starts a handwriting input at any position outside the frame surrounding the object.

The handwriting input acceptance unit (handwriting acceptance unit) 5 accepts handwriting (handwriting information) input by the user via handwriting to the image displayed on the display unit 14 using the operation unit 15. More specifically, the handwriting input acceptance unit 5 acquires coordinate values (handwriting information) of points representing a locus (handwriting) from a position at which the operation unit 15 starts contact with the image displayed on the display unit 14 to a position at which the operation unit 15 finishes contact with the display unit 14 displaying the image. The coordinate values indicating the handwriting is represented by coordinate values (x, y) with respect to a prescribed reference position (0, 0). Accordingly, a one stroke of the handwriting here is represented by coordinate values of a plurality of points. The reference position (0, 0) is, for instance, the top left point in a region displayable on the display unit 14.

The handwriting input acceptance unit 5 transmits coordinate values (handwriting information) acquired at any time to the input status determination unit 6 and the display processor 4. Every time acceptance of one stroke of the handwriting is finished, the handwriting input acceptance unit 5 interleaves information representing completion of one stroke of the handwriting into the handwriting information and transmits the interleaved information to the input status determination unit 6 and the display processor 4. Thus, the input status determination unit 6 and the display processor 4 divide the acquired handwriting information into units of strokes.

In the display processor 4 having acquired the coordinate values representing the points of the handwriting, the handwriting display unit (handwriting display means) 43 plots the acquired points on the image on the display unit 14, and displays a line between the plotted point and the point plotted immediately therebefore in the same handwriting. Thus, pieces of the input handwriting are sequentially displayed on the displayed image.

In a case where an input of coordinate values via the handwriting input acceptance unit 5 is started, the input status determination unit (determination unit) 6 determines whether the started handwriting input is a comment input or not on the basis of the input coordinate values and the stored contents of the detection region table 13a. More specifically, the input status determination unit 6 determines whether the handwriting by the started handwriting input is for any object region or not.

Here, in the PC 100 of this Embodiment 1, input statuses when the user performs a handwriting input include a normal input status and a comment input status. Information input via handwriting in the comment input status is placed in the comment placement region adjacent to the corresponding object (here, the person), assigned with a comment balloon and displayed on the image. On the other hand, information input via handwriting input in the normal input status is displayed on the image without any change of the input position and the size.

According to the PC 100 of this Embodiment 1, in a case where a handwriting input is started in any frame representing the object region of the image, it is determined that a comment input to the object is started and the comment input status is set. On the other hand, in a case where a handwriting input is started outside the frame representing the object region in the image, it is determined that a normal input is started and the normal input status is set. In the PC 100 of this Embodiment 1, the normal input status is set as an initial setting. Accordingly, when a comment input is started, the comment input status is set.

The input status determination unit 6 determines whether or not the coordinate values of the starting position of the first stroke of handwriting input from the handwriting input acceptance unit 5 are included in any one of the object regions indicated by the object region information stored in the detection region table 13a. In a case where the starting position of the first stroke is not included in any one of the object regions, the input status determination unit 6 determines that the started handwriting input is a normal input and does not perform any process.

On the other hand, in a case where the starting position of the first stroke is included in any one of the object regions, the input status determination unit 6 determines that the started handwriting input is a comment input and sets the comment input status. FIGS. 6 (a) and 6(b) illustrate an example where a character “A” is started to be written in the object region O2. Accordingly, in a situation illustrated in FIGS. 6 (a) and 6 (b), the input status determination unit 6 determines that a comment input has been started and sets the comment input status. In a case of setting the comment input status, the input status determination unit 6 starts storing of coordinate values (information of comment-equivalent handwriting) acquired from the handwriting input acceptance unit 5 in a comment-equivalent handwriting buffer.

In a case of setting the comment input status, the input status determination unit (object identification unit) 6 identifies the object region including the starting position of the first stroke. In the situation illustrated in FIGS. 6 (a) and 6 (b), the input status determination unit 6 identifies the object region O2. The input status determination unit 6 reads the object region ID of the identified object region from the detection region table 13a, and stores the read object region ID in an object buffer. The input status determination unit 6 uses, for instance, a prescribed region of the RAM 12 as the object buffer and the comment-equivalent handwriting buffer.

After the user has started the comment input as described above, in a case where the input of the coordinate values from the handwriting input acceptance unit 5 has been broke for a prescribed time (e.g. 10 seconds), the input status determination unit 6 determines that the user has finished the comment input. In a case of determining that the comment input has been finished, the input status determination unit 6 notifies the comment processor 3 that the comment input is finished.

In a case of notification that the comment input has been finished, the object identification unit 31 of the comment processor 3 reads the object region ID stored in the object buffer, and notifies the comment placement region identification unit 32 of the read object region ID. The comment placement region identification unit (placement region identification unit) 32 reads from the detection region table 13a the comment placement region ID corresponding to the object region ID acquired from the object identification unit 31, and notifies the comment region calculator 34 of the read comment placement region ID.

In a case of notification that the comment input has been finished, the comment-equivalent handwriting extractor 33 of the comment processor 3 reads the coordinate values (information representing the comment-equivalent handwriting) stored in the comment-equivalent handwriting buffer, and transmits the read coordinate values to the comment region calculator 34. The comment-equivalent handwriting extractor 33 transmits the coordinate values read from the comment-equivalent handwriting buffer also to the comment size changing unit 35.

The comment region calculator 34 detects a rectangular input comment region that includes the comment-equivalent handwriting indicated by the acquired coordinate values and has the minimum area on the basis of the coordinate values (information representing the comment-equivalent handwriting) acquired from the comment-equivalent handwriting extractor 33. In the situation illustrated in FIG. 6 (b), a region R is detected as an input comment region.

The comment region calculator 34 reads from the detection region table 13a the comment placement region information corresponding to the comment placement region ID notified by the comment placement region identification unit 32. In the situation illustrated in FIG. 6 (b), the comment region calculator 34 reads the comment placement region information of the comment placement region C2 corresponding to the object region O2.

The comment region calculator (calculator) 34 calculates a size changing ratio between the comment placement region C2 indicated by the comment placement region information read from the detection region table 13a and the detected input comment region R. More specifically, the comment region calculator 34 calculates a scaling ratio for a scaling process applied to the input comment region R, in order to place the input comment region R in the comment placement region C2.

The comment region calculator 34 calculates a size changing ratio for changing the length of the input comment region R in a vertical direction (y axis direction) into the length of the comment placement region C2 in the vertical direction. The comment region calculator 34 further calculates a size changing ratio for changing the length of the input comment region R in the horizontal direction (x axis direction) into the length of the comment placement region C2 in the horizontal direction. The comment region calculator 34 determines the smaller one of the calculated size changing ratios as the size changing ratio for changing the input comment region R into the comment placement region C2. Accordingly, for instance, in a case where the size changing ratio in the vertical direction is 0.7 and the size changing ratio in the horizontal direction is 0.5, the size changing ratio is determined as 0.5. Thus, an identical magnification process can be applied to a handwriting input via handwriting using the calculated size changing ratio.

The comment region calculator 34 calculates the lengths of the comment region in the vertical and horizontal directions after the input comment region R has been changed in size according to the calculated size changing ratio. The comment region calculator (display region extraction unit) 34 identifies the position of the comment region represented by the calculated lengths in the vertical and horizontal directions in the comment placement region C2. The comment region calculator 34 identifies the position where the distance from the object region O2 is the minimum in the comment placement region C2 as the position of the comment region.

The comment region calculator 34 calculates the coordinate values of the top left and bottom right points of the comment region in order to represent the position of the identified comment region, and notifies the display processor 4 of the coordinate values. The comment region calculator 34 notifies the comment size changing unit 35 of the calculated size changing ratio.

In a case where the size changing ratio is notified, the comment size changing unit (scaling unit) 35 changes the size of the comment-equivalent handwriting represented by the coordinate values acquired from the comment-equivalent handwriting extractor 33 according to the notified size changing ratio. The comment size changing unit 35 transmits the coordinate values representing the comment-equivalent handwriting after the size change to the display processor 4.

The comment display unit 44 of the display processor 4 acquires the coordinate values of the top left and bottom right points of the comment region from the comment region calculator 34, and acquires the coordinate values representing the comment-equivalent handwriting after the size change from the comment size changing unit 35. The comment display unit (scaled handwriting display unit) 44 displays the comment-equivalent handwriting after the size change in the comment region based on the coordinate values of the top left and bottom right points of the comment region on the image displayed on the display unit 14. In a case where the comment display unit 44 displays the comment-equivalent handwriting after the size change on the display unit 14, the handwriting display unit 43 finishes the display of the handwriting input by the user as the comment.

In a case where the comment display unit 44 displays the comment-equivalent handwriting after the size change in the comment region identified by the comment region calculator 34, the comment display unit 44 notifies the comment balloon display unit 45 of this display. In a case where the comment balloon display unit (association display unit) 45 is notified that the display of the comment-equivalent handwriting after the size change has been completed, the comment balloon display unit 45 displays the comment balloon surrounding the comment region on the image displayed on the display unit 14. FIG. 6 (c) illustrates an example where the comment-equivalent handwriting input into the object region O2 as the comment is displayed adjacent to the object region O2 in the comment placement region C2 and surrounded by the comment balloon. FIG. 6 (c) illustrates the background of the comment region in white in order to enhance the displayed comment. However, only the comment may be displayed on the image.

When the user starts a handwriting input, the PC 100 of this Embodiment 1 determines whether the started handwriting input is a comment input or not using the aforementioned units. In a case where the PC 100 determines that the input is a comment input, the PC 100 executes the comment process on the input information (handwriting) and thereby displays the comment balloon attached adjacent to the corresponding object.

When the user of the PC 100 performs a prescribed operation for starting the edit process on the image, the units of the image processor 2, the image display unit 41 and the object region display unit 42 execute the aforementioned processes. When the user of the PC 100 starts a handwriting input to the image displayed on the display unit 14, the handwriting input acceptance unit 5, the input status determination unit 6, the units of the comment processor 3, the handwriting display unit 43, the comment display unit 44 and the comment balloon display unit 45 execute the aforementioned processes.

The image processor 2 generates the detection region table 13a after the image reader 1 reads the image data. This reduces a response time in which the user performs the handwriting input and then some response is returned to the user.

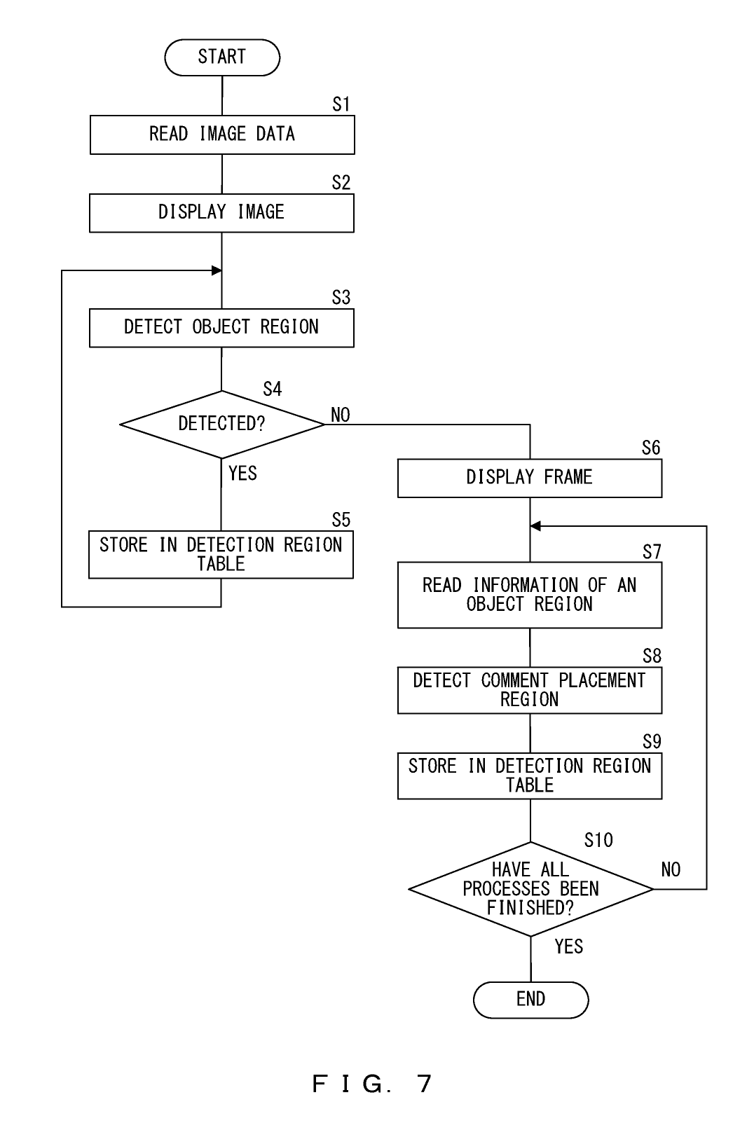

Hereinafter, a process executed by the controller 10 when the user performs a prescribed operation for starting the edit process on the image in the PC 100 of this Embodiment 1 will be described on the basis of a flowchart. FIG. 7 is a flowchart illustrating procedures of a process of generating the detection region table 13a of Embodiment 1. The following process is executed by the controller 10 according to the control program stored in the ROM 11 or the storage 13 of the PC 100.

When the user performs the prescribed operation for starting the edit process to the image, the controller 10 reads image data designated by the user from the storage 13 (S1). The controller 10 displays an image based on the read image data on the display unit 14 (S2). The controller 10 detects a region of a certain object (the face of a person) in the read image data (S3). The controller 10 determines whether the region of the certain object has been detected or not (S4). If the controller 10 determines that the region has been detected (S4: YES), the controller 10 stores the object region ID and the object region information of the detected object region in the detection region table 13a (S5).

The controller 10 returns the process to step S3, and detects a region of another object (the face of a person) in the read image data (S3). The controller 10 repeats the processes in steps S3 to S5 until detection of the regions of all the objects in the image data is finished. In the case where the controller 10 has detected the regions of all the objects in the image data, the controller 10 displays frames surrounding the respective regions detected on the image displayed on the display unit 14. That is, if the controller 10 determines that the region of a certain object is undetectable in the image data (S4: NO), the controller 10 displays frames surrounding the object regions (face regions) on the basis of the object region information stored in the detection region table 13a (S6). The controller 10 may display the frame surrounding the object region every time the controller 10 detects an object region in the image data.

Next, the controller 10 reads information (the object region ID and the object region information) of one of the object region stored in the detection region table 13a (S7). The controller 10 detects the comment placement region corresponding to the read object region on the basis of information of this object region (S8). More specifically, the controller 10 determines a region that is adjacent to the object region and does not overlap with any one of the object regions as the comment placement region for this object region. The controller 10 stores the comment placement region ID and the comment placement region information of the detected comment placement region in the detection region table 13a (S9).

The controller 10 determines whether the processes for the information of all the object regions stored in the detection region table 13a have been finished or not (S10). If the controller 10 determines that the processes have not been finished yet (S10: NO), the controller 10 returns the process to the step S7. The controller 10 reads information of another object region stored in the detection region table 13a (S7), and executes the processes in steps S8 and S9 on the information of the read object region. The controller 10 repeats the processes in step S7 to S10 until the controller 10 finishes the processes on the information of all the object regions stored in the detection region table 13a.

If the controller 10 determines that the processes on the information of all the object regions stored in the detection region table 13a have been finished (S10: YES), the controller 10 finishes the aforementioned process. According to this Embodiment 1, such processing allows the comment placement regions to be secured for the respective prescribed objects (e.g. the faces of people) in the image at the time when the edit process on the image is started. Accordingly, in a case of actually placing a comment, use of the information stored in the detection region table 13a allows the process to be simplified and executed at high speed.

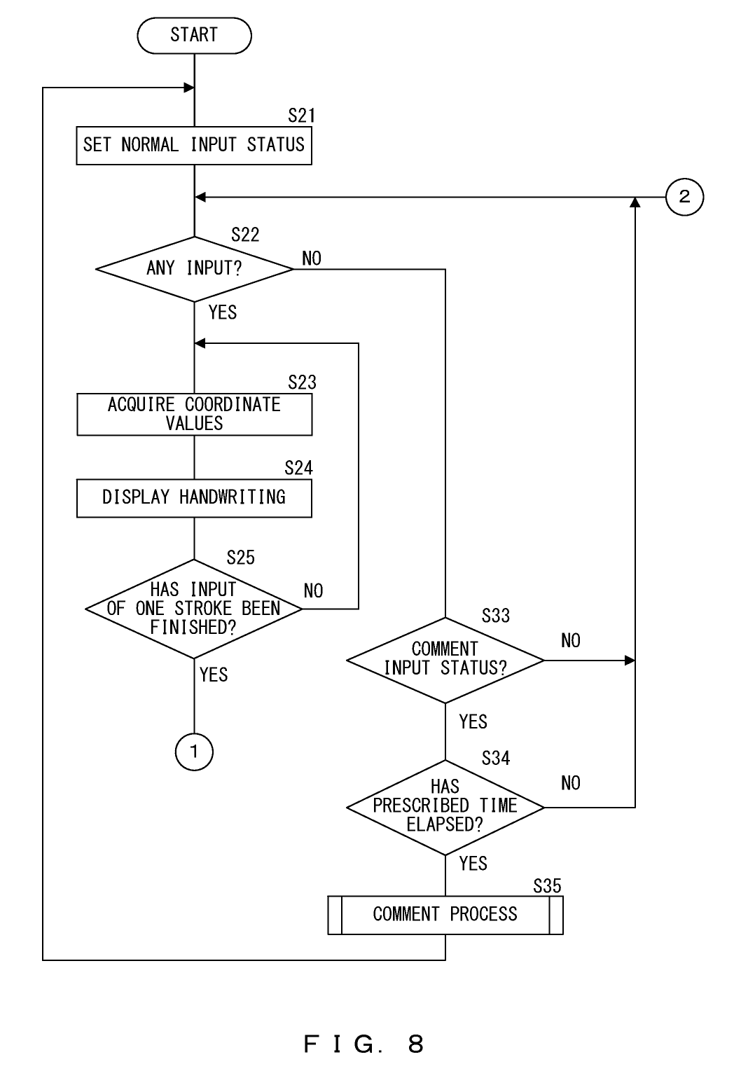

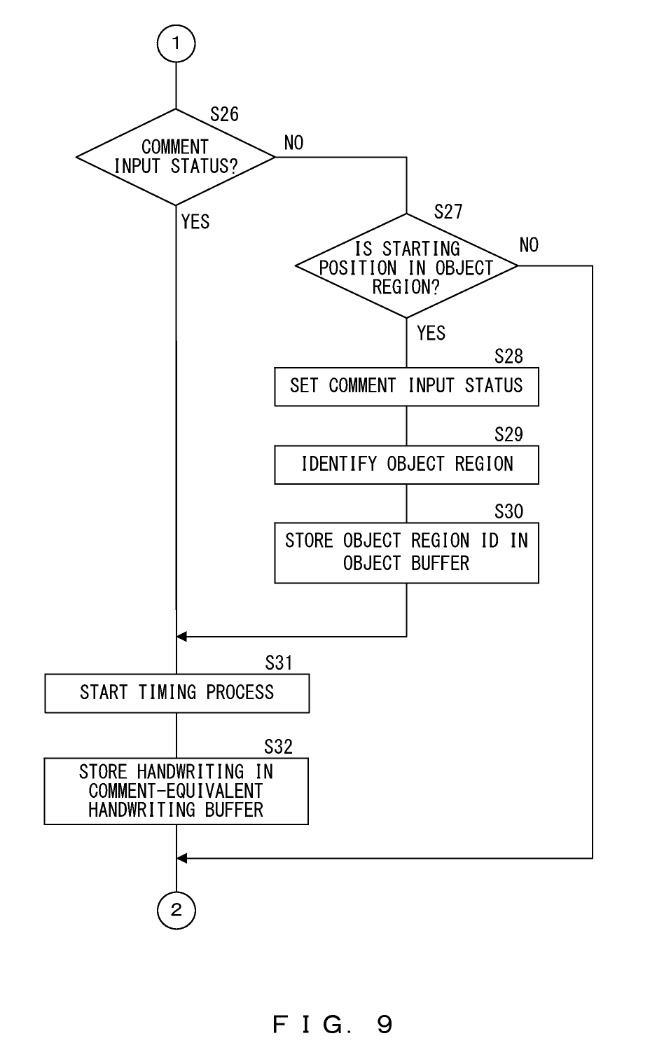

Next, in the PC 100 displaying the image and the frames surrounding the respective object regions as described above, processes executed by the controller 10 when the user started a handwriting input to the image will be described on the basis of flowcharts. FIGS. 8 and 9 are flowcharts illustrating procedures of processes executed by the PC 100 of Embodiment 1. The following processes are executed by the controller 10 according to the control program stored in the ROM 11 or the storage 13 of the PC 100.

The controller 10 sets the normal input status as the initial setting (S21). In the PC 100 displaying the image and the frames surrounding the object regions on the display unit 14 as illustrated in FIG. 5 (b), the controller 10 determines whether there is a handwriting input to the image by the user or not (S22). If the controller 10 determines that there is a handwriting input (S22: YES), the controller 10 acquires the coordinate values of the points representing the handwriting input via handwriting (S23) and, for instance, temporarily stores the values in the RAM 12. The controller 10 displays the handwriting input via handwriting on the image displayed on the display unit 14 on the basis of coordinate values acquired as occasion arises (S24).

The controller 10 determines whether the input of the one stroke of the handwriting has been finished or not (S25). If the controller 10 determines that the input has not been finished yet (S25: NO), the controller 10 returns the process to step S23. The controller 10 repeats the processes in steps S23 to S25 until the input of the one stroke of the handwriting has been finished. If the controller 10 determines that the input of the one stroke of the handwriting has been finished (S25: YES), the controller 10 determines whether or not the comment input status is set at this time (S26).

If the controller 10 determines that the comment input status is set (S26: YES), the controller 10 advances the process to step S31. The normal input status is set at the time when the first stroke of handwriting is input, the controller 10 determines that the comment input status is not set. If the controller 10 determines that the comment input status is not set (S26: NO), the controller 10 determines whether or not the starting position of the input first stroke of handwriting is included in any one of the object regions indicated by the object region information stored in the detection region table 13a (S27).

If the controller 10 determines that the starting position of the first stroke is not included in any one of the object regions (S27: NO), that is, in a case where the started handwriting input is not a comment input but drawing (normal input) to the image, the controller 10 returns the process to step S22. On the other hand, the controller 10 determines that the starting position of the first stroke is included in any one of the object regions (S27: YES), the controller 10 determines that the started handwriting input is a comment input, and sets the comment input status (S28).

The controller 10 identifies the object region in which the controller 10 determines that the starting position of the first stroke is included in step S27 (S29). The controller 10 reads the object region ID of the identified object region from the detection region table 13a, and stores the read object region ID in the object buffer (S30). The controller 10 starts a process of calculating a prescribed time (e.g. 10 seconds) (S31). The timing process here is a process for determining whether or not the user has finished the comment input after the input of one stroke of handwriting. That is, after the input of one stroke of handwriting, if there is no handwriting input by the user until a prescribed time elapses, the controller 10 determines that the user has finished the comment input.

The controller 10 stores the coordinate values representing the one stroke (the first stroke) of handwriting acquired in step S23 in the comment-equivalent handwriting buffer (S32). The controller 10 returns the process to step S22, and determines whether there is an input of the next one stroke (the second stroke) of handwriting via handwriting input by the user or not (S22). If the controller 10 determines that there is the input of the next one stroke (the second stroke) of handwriting (S22: YES), the controller 10 repeats the processes in steps S23 to S25 and temporarily stores in the RAM 12 the coordinate values of the points representing the next one stroke (the second stroke) of handwriting.

The controller 10 determines whether or not the comment input status is set at this time (S26). In the case of the second stroke of handwriting is input, the controller 10 is determines that the comment input status is set (S26: YES) and restarts the process of calculating the prescribed time (e.g. 10 seconds) (S31). The controller 10 stores the coordinate values representing the one stroke (the second stroke) of handwriting acquired in step S23 in the comment-equivalent handwriting buffer (S32).

The controller 10 returns the process to step S22, and determines whether or not there is any input of one stroke (the third stroke) of handwriting via handwriting input by the user (S22). The controller 10 repeats the processes in steps S22 to S32 until the input of the next one stroke of handwriting via handwriting input by the user is broken. If the controller 10 determines that there is no input of the next one stroke of handwriting via handwriting by the user (S22: NO), the controller 10 determines whether or not the comment input status is set at this time (S33).

If the controller 10 determines that the comment input status is set (S33: YES), the controller 10 determines that the prescribed time has elapsed or not on the basis of the result of the timing process started in step S31 (S34). If the controller 10 determines that the comment input status is not set (S33: NO) or that the prescribed time has not elapsed yet (S34: NO), the controller 10 returns the process to step S22.

If the controller determines that the prescribed time has elapsed (S34: YES), the controller 10 determines that the user has finished the comment input, executes the comment process (S35), and returns the process to step S21 after execution of the comment process. The comment process will be described in detail later.

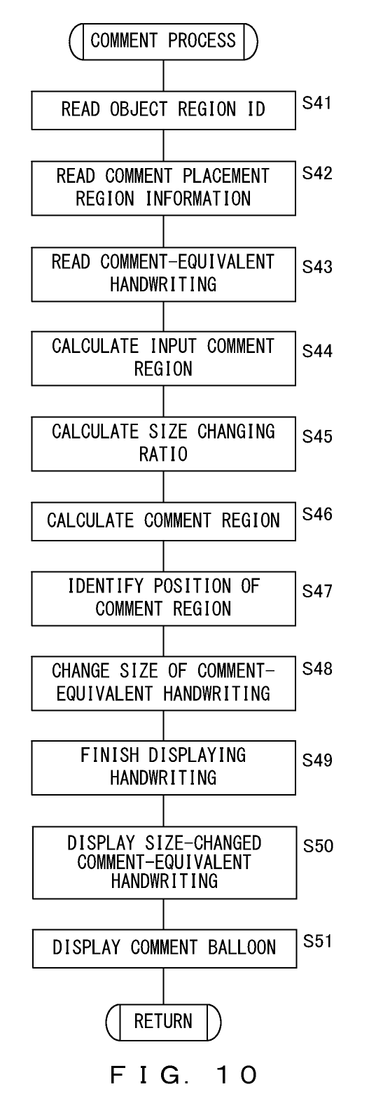

Next, the comment process (the process in step S35 in FIG. 8) in the aforementioned processes in the PC 100 will be described on the basis of a flowchart. FIG. 10 is a flowchart illustrating procedures of the comment process of Embodiment 1. The following processing is executed by the controller 10 according to the control program stored in the ROM 11 or the storage 13 of the PC 100.

The controller 10 reads the object region ID stored in the object buffer (S41). The controller 10 reads the comment placement region information corresponding to the read object region ID from the detection region table 13a (S42). The controller 10 reads the coordinate values (information representing the comment-equivalent handwriting) stored in the comment-equivalent handwriting buffer (S43). The controller 10 calculates a rectangular input comment region in which the comment-equivalent handwriting is included and the area is the minimum on the basis of the coordinate values read from the comment-equivalent handwriting buffer (S44).

The controller 10 calculates the size changing ratio for placing the input comment region calculated in step S44 in the comment placement region indicated by the comment placement region information read in step S42 (S45). The controller 10 calculates a comment region with a size changed from that of the input comment region according to the calculated size changing ratio (S46). More specifically, the controller 10 calculates the lengths of the comment region in the vertical and horizontal directions.

The controller 10 identifies the position of the comment region calculated in step S46 in the comment placement region indicated by the comment placement region information read in step S42 (S47). The controller 10 changes the size of the comment-equivalent handwriting indicated by the coordinate values read in the step S43 according to the size changing ratio calculated in step S45 (S48). The controller 10 finishes the display of the handwriting displayed in step S24 of FIG. 8 (S49).

The controller 10 displays the comment-equivalent handwriting changed in size in step S48 in the comment region at the position identified in step S47 (S50). The controller 10 displays the comment balloon corresponding to the comment-equivalent handwriting displayed in step S50 (S51). The controller 10 finishes the aforementioned comment process and returns the process to that illustrated in FIG. 8.

As described above, when the user started the handwriting input, the PC 100 of this Embodiment 1 determines whether the started handwriting input is a comment input or a normal input. Accordingly, the user may designate whether the input is a comment input to a desired object (person) or a drawing operation to a desired position by starting the handwriting input at a desired position in the image displayed on the display unit 14. More specifically, in a case where the user wishes to add comment information to any object in the image displayed on the display unit 14, it suffices that the user starts to input the comment information in the frame surrounding a desired object.

Conventionally, addition of a comment to the image requires an operation of setting a comment input mode, an operation for designating which person the comment information is to be added to in the image, an operation for inputting the comment information and the like. However, in this Embodiment 1, the user thus starts the handwriting input at the desired position, which replaces these operations. Therefore, the user does not need to perform special operations, thereby increasing usability for the user.

If the PC 100 of this Embodiment 1 determines that the started handwriting input is a normal input, the PC 100 does not execute the comment process on the information input by the user and let the information displayed on the image. Accordingly, the PC 100 of this Embodiment 1 does not prevent execution of a drawing process according to the drawing operation to a region other than the object region in the image.

The PC 100 of this Embodiment 1 changes the size of the handwriting input via handwriting and subsequently displays the handwriting in an appropriate comment placement region on the image displayed on the display unit 14. Accordingly, although the size of the comment region in which the comment is actually displayed is subject to a certain limitation, the size of the input comment region for inputting the comment is not limited. This facilitates a comment input by the user.

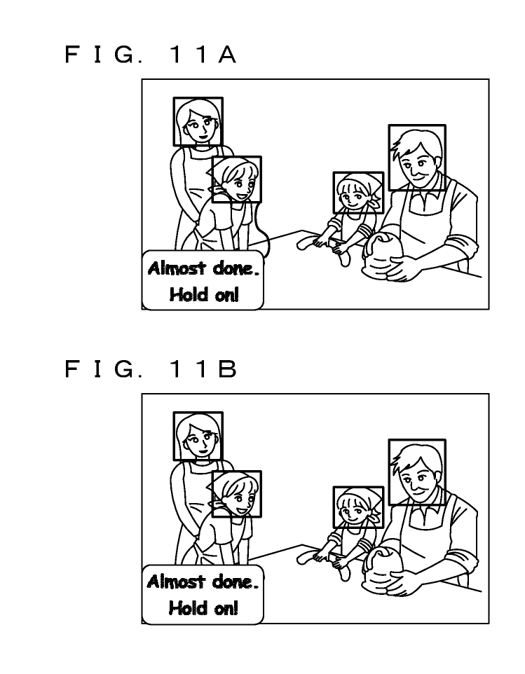

The PC 100 of this Embodiment 1 displays the handwriting input as a comment in the comment placement region adjacent to the corresponding object, and adds the comment balloon to the displayed handwriting. This allows the comment with the comment balloon to be added to any person in the image. FIG. 11 is a schematic diagram illustrating a variation of an image to which a comment is added. In addition to the comment balloon, a symbol indicating association with any person in the image, such as a leader line depicted in FIG. 11 (a) may be added to the comment added to the image.

Instead, as illustrated in FIG. 11 (b), the symbol indicating association with any person in the image is not added but only a comment may be displayed. Even with such a display method, the comment added to the image is displayed adjacent to the object to be associated. Accordingly, the person associated by the arranged position of the comment may easily be estimated.

### Embodiment 2

A PC according to Embodiment 2 will hereinafter be described. The PC of this Embodiment 2 is realized by a configuration analogous to that of the aforementioned PC 100 of Embodiment 1. Accordingly, analogous configurational elements are assigned with the identical symbols. The description thereof is omitted.

When a handwriting input is started in a region of an object (the face of a person) in the image displayed on the display unit 14, the aforementioned PC 100 of Embodiment 1 determines whether the comment input is started or not. The PC 100 of this Embodiment 2 regards a prescribed extent in the region of the object (the face of a person) in the image displayed on the display unit 14 as a determination region, and determines whether the comment input is started or not when the handwriting input is started in any one of the determination regions.

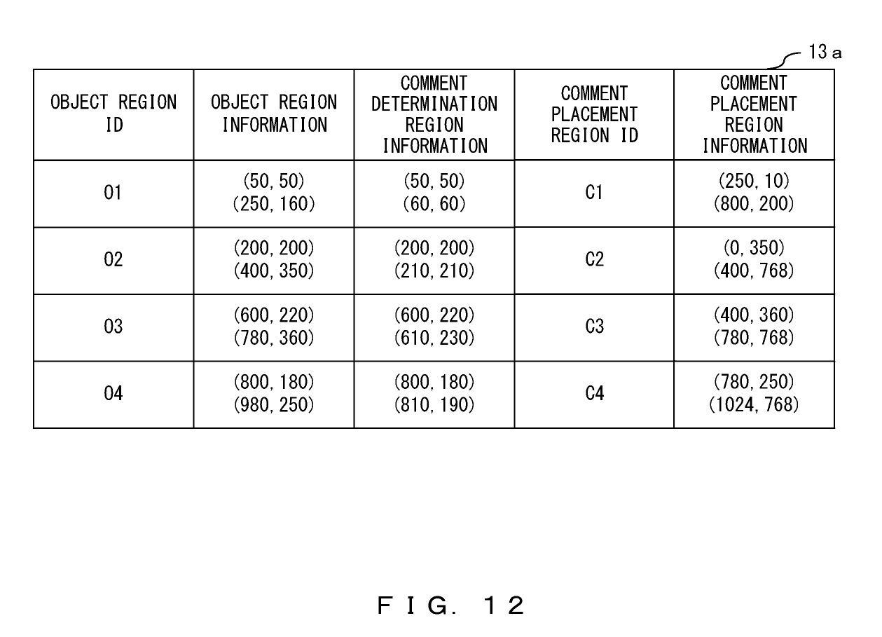

FIG. 12 is a schematic diagram illustrating stored contents of the detection region table 13a of Embodiment 2. As illustrated in FIG. 12, the detection region table 13a of this Embodiment 2 stores comment determination region information in addition to the object region ID, the object region information, the comment placement region ID and the comment placement region information. The comment determination region information is information representing a comment determination region for determining whether the comment input to the corresponding object (object region) is started or not. The points of the top left and the bottom right of the each comment determination region are represented by coordinate values with respect to a prescribed reference position.

The reference position (0, 0) is, for instance, the point of the top left of a region displayable on the display unit 14. The coordinate values (x, y) of the points of the top left and the bottom right of each comment determination region are represented using the right and downward directions from the reference position (0, 0) as the x and y coordinate axes, respectively. In this Embodiment 2, the comment determination region is a region with a prescribed size (e.g. 10 pixels×10 pixels) at the top left of each object region. Instead of such a region, the comment determination region may be a region with a prescribed size at the bottom left, a region with a prescribed size at the top right, a region with a prescribed size at the bottom right or the liken in each object. Further, for instance, a region of hair or a region of skin may be detected in the region of the object (the face of a person), and the detected region or a region other than the detected region may be a comment determination region.

The comment determination region information to be stored in the detection region table 13a is stored therein by the controller 10 every time the controller 10 detects an object region in the image and detects a comment determination region on the basis of the detected object region.

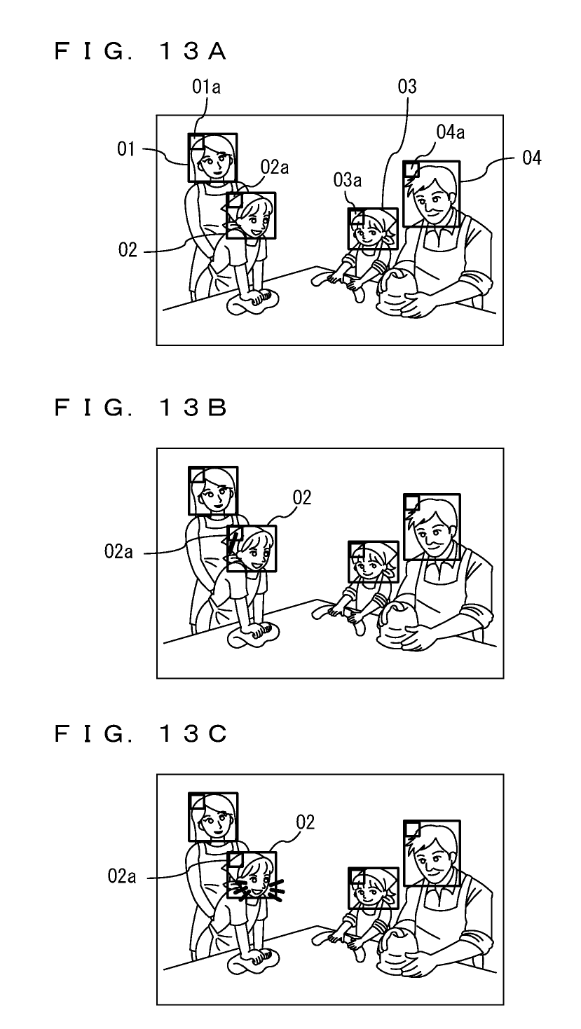

Functions realized by the PC 100 of this Embodiment 2 will hereinafter be described. The controller 10 of the PC 100 of this Embodiment 2 realizes the functions illustrated in FIGS. 3 and 4 by executing the control program stored in the ROM 11 or the storage 13. FIG. 13 is a schematic diagram for illustrating processes executed by the PC 100 of Embodiment 2.

The object detector 21 of this Embodiment 2 determines whether the image data acquired from the image reader 1 includes a certain object (e.g. the face of a person) having been imaged or not as with the aforementioned object detector 21 of Embodiment 1. In a case where the object detector 21 detects that the face of a person has been imaged in the image data, the object detector 21 detects a rectangular object region including the detected face. In a case where the object detector 21 detects the object region, the object detector 21 calculates a comment determination region for the detected object region.

More specifically, the object detector 21 calculates a region with a prescribed size (e.g. 10 pixels×10 pixels) at the top left of the detected object region. The object detector 21 assigns object region IDs in the order of detection of the object regions, and stores in the detection region table 13a the object region information indicating the detected object region and the comment determination region information indicating the calculated comment determination region in association with the assigned object region ID.

The object detector 21 of this Embodiment 2 detects all the object regions in the image data and the comment determination regions for the respective object regions, and stores the object region IDs, the object region information and the comment determination region information in the detection region table 13a. After detection of all the object regions, the object detector 21 reads the object region information and the comment determination region information stored in the detection region table 13a and transmits the read information to the display processor 4.

The object region display unit 42 of this Embodiment 2 displays the frames surrounding the respective object regions (face regions) on the image displayed on the display unit 14 on the basis of the object region information acquired from the object detector 21, as with the aforementioned object region display unit 42 of Embodiment 1. The object region display unit (determination region display unit) 42 of this Embodiment 2 also displays the frames surrounding the comment determination regions in the respective object regions on the basis of the comment determination region information acquired from the object detector 21.

FIG. 13 (a) illustrates an example where the frames surrounding the respective object regions and comment determination regions are displayed on the image by the object region display unit 42. In FIG. 13 (a), reference symbols O1, O2, O3 and O4 denote object regions; reference symbols O1a, O2a, O3a and O4a denote comment determination regions corresponding to the respective object regions O1, O2, O3 and O4.

After the object detector 21 has detected all the object regions, the object region display unit 42 displays the object regions O1, O2, O3 and O4 and the frames surrounding the comment determination regions O1a, O2a, O3a and O4a. However, the object region display unit 42 may display the object regions O1, O2, O3 and O4 and the frames surrounding the respective comment determination regions O1a, O2a, O3a and O4a every time the object detector 21 detects an object region and a comment determination region.

In this Embodiment 2, as to the image on which the frames surrounding the respective object regions and comment determination regions are displayed, in a case where the user wishes to add comment information to a desired object, the user starts handwriting input in the frame surrounding the comment determination region in the object region of the desired object.

The input status determination unit 6 of this Embodiment 2 determines whether the coordinate values of the starting position of the first stroke of handwriting input from the handwriting input acceptance unit 5 is included in any one of the comment determination regions indicated by the comment determination region information stored in the detection region table 13a. If the starting position of the first stroke is not included in any one of the comment determination regions, the input status determination unit 6 determines that the started handwriting input is a normal input and does not execute any process.

On the other hand, if the starting position of the first stroke is included in any one of the comment determination regions, the input status determination unit 6 determines that the started handwriting input is a comment input and sets the comment input status. FIG. 13 (b) illustrates an example where the first stroke of a character “A” is started to be written in the comment determination region O2a. Accordingly, in the situation illustrated in FIG. 13 (b), the input status determination unit 6 determines that the comment input is started and sets the comment input status.

FIG. 13 (c) illustrates an example where the handwriting is started at a position outside the comment determination region O2a in the object region O2. The input status determination unit 6 of this Embodiment 2 determines that the handwriting input started in the comment determination region O2a is a comment input. Accordingly, as illustrated in FIG. 13 (c), even in the object region O2, the input status determination unit 6 determines that the handwriting input started at a position outside the comment determination region O2a is not a comment input. Accordingly, as illustrated in FIG. 13 (c), a drawing, a character or the like written outside the comment determination region O2a in the object region O2 is displayed at the position and in a size as it is.

Since the comment determination region is in the object region, when the input status determination unit 6 determines that the comment input is started, the input status determination unit 6 determines the object region including the starting position of the first stroke of handwriting according to the process described in the aforementioned Embodiment 1. The input status determination unit 6 may determine the object region including the comment determination region including the starting position of the first stroke.

In a case where the input status determination unit 6 sets the comment input status, the input status determination unit 6 starts to store the coordinate value (information representing the comment-equivalent handwriting) acquired from the handwriting input acceptance unit 5 in the comment-equivalent handwriting buffer. The input status determination unit 6 reads the object region ID of the identified object region from the detection region table 13a, and stores the read object region ID in the object buffer.

Thus, in this Embodiment 2, even in a case where a handwriting input is started in the object region O2, if started in a position other than the comment determination region O2a in the object region O2, the comment process is not executed. Accordingly, limitation on the condition for determining that the started handwriting input is not a comment input may relax the condition for determining that a drawing started in the object region O2 is a drawing to which the comment process is not applied.

Units other than the object detector 21, the object region display unit 42 and the input status determination unit 6 of this Embodiment 2 executes processes similar to those described in the aforementioned Embodiment 1.

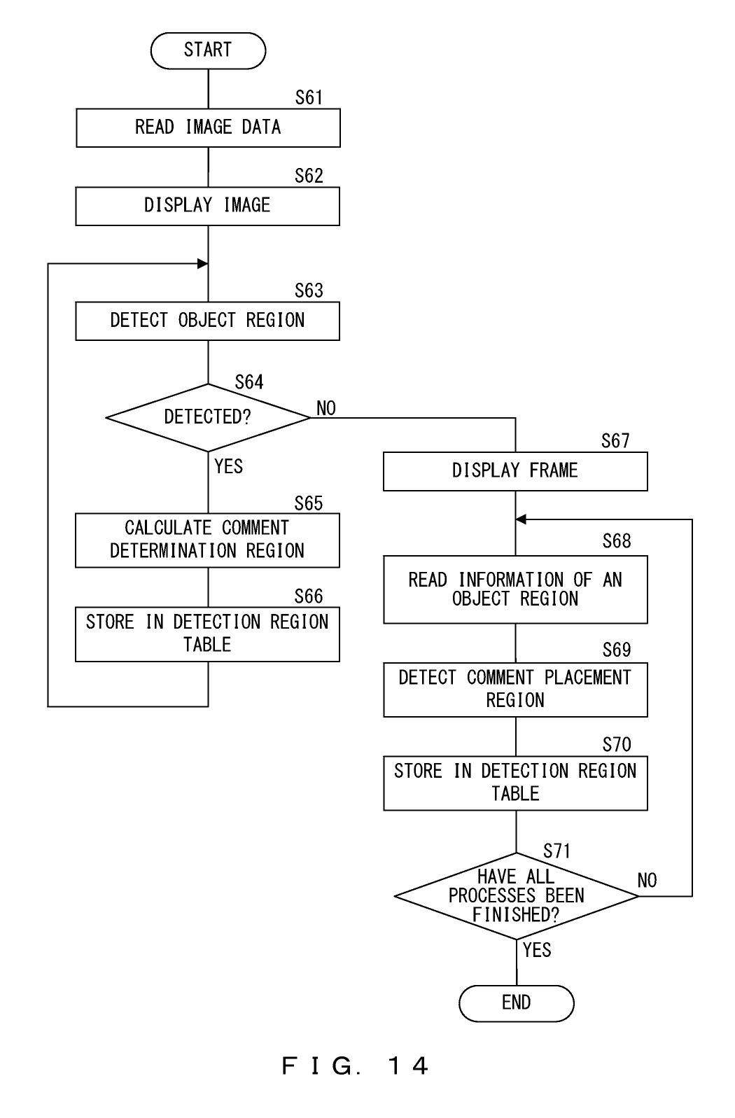

Hereinafter, the process executed by the controller 10 in a case where the user performs a prescribed operation for starting the edit process in the PC 100 of this Embodiment 2 will be described on the basis of a flowchart. FIG. 14 is a flowchart illustrating procedures of a process for generating the detection region table 13a of Embodiment 2. The following process is executed by the controller 10 according to a control program stored in the ROM 11 or the storage 13 of the PC 100.

When the user performs the prescribed operation for starting the edit process on an image, the controller 10 reads image data designated by the user from the storage 13 (S61). The controller 10 displays an image based on the read image data on the display unit 14 (S62). The controller 10 detects a region of a prescribed object (the face of a person) in the read image data (S63). The controller 10 determines whether the region of the certain object is detected or not (S64). If the controller 10 determines that the region is detected (S64: YES), the controller 10 calculates a comment determination region for the detected object region (S65).

The controller 10 stores the object region ID and the object region information of the detected object region and the comment determination region information indicating the comment determination region calculated in step S65 in the detection region table 13a (S66). The controller 10 returns the process to step S63, and detects the region of another object (the face of a person) in the read image data (S63). The controller 10 repeats the processes in steps S63 to S66 until the controller 10 detects the regions of all the objects in the image data.

In the case of detecting the regions of all the objects in the image data, the controller 10 displays frames surrounding the detected object regions and the comment determination regions on the image displayed on the display unit 14. That is, if the controller 10 determines that the region of the object is undetectable (S64: NO), the controller 10 displays the frames surrounding the object regions and the comment determination regions on the basis of the object region information and the comment determination region information stored in the detection region table 13a (S67). The controller 10 may display the frames surrounding the respective object regions and the frames surrounding the respective comment determination region every time the controller 10 detects an object region and a comment determination region in the image data.

Next, the controller 10 reads the object region information (the object region ID and the object region information) of one object region stored in the detection region table 13a (S68). The controller 10 detects the comment placement region for the object region on the basis of the read object region information (S69). The controller 10 stores the comment placement region ID and the comment placement region information of the detected comment placement region in the detection region table 13a (S70).

The controller 10 determines whether the processing on all the pieces of the object region information stored in the detection region table 13a has been finished or not (S71). If the controller 10 determines that the processing has not been finished yet (S71: NO), the controller 10 returns the process to step S68. The controller 10 reads the object region information of another object region stored in the detection region table 13a (S68), and executes the processes insteps S69 and S70 on the read object region information. The controller 10 repeats the processes insteps S68 to S71 until the controller 10 has finished the processing on all the pieces of the object region information stored in the detection region table 13a.

If the controller 10 determines that the processing on all the pieces of the object region information stored in the detection region table 13a has finished (S71: YES), the controller 10 finishes the aforementioned process. According to such processes, in this Embodiment 2, the comment placement regions for the respective prescribed objects (e.g. the faces of people) in the image is determined at the time of starting the process of editing the image and calculate the comment determination region.

In the PC 100 of this Embodiment 2, the process performed by the controller 10 when the user starts a handwriting input to the image displayed on the display unit 14 is similar to the processes described in FIGS. 8 and 9 of the aforementioned Embodiment 1. When the handwriting input is started, the PC 100 of this Embodiment 2 determines whether the started handwriting input is a comment input or a normal input on the basis of whether the starting position of the first stroke of handwriting is included in any one of the comment determination regions or not. Accordingly, in step S27 of FIG. 9, the controller 10 of this Embodiment 2 determines whether the starting position of the input first stroke of the handwriting is included in any one of comment determination regions indicated by the comment determination region information stored in the detection region table 13a or not.

In the PC 100 of this Embodiment 2, the comment process executed by the controller 10 is similar to that described in FIG. 10 of the aforementioned Embodiment 1.

As described above, in the PC 100 of this Embodiment 2, a handwriting input is started at a desired position in the image displayed on the display unit 14, thereby allowing designation of whether the input is a comment input to a desired object (person) or a drawing operation to a desired position. More specifically, in a case where the user wishes to add comment information to any object in the image displayed on the display unit 14, it suffices that the user starts an input of the comment information in the comment determination region corresponding to the desired object.

In this Embodiment 2, the comment process is not executed when the handwriting input by the user starts in a region outside the comment determination region, even if the input is made in the object region. This relaxes the condition of determining that the input is a drawing not to be subjected to the comment process.

### Embodiment 3

A PC according to Embodiment 3 will hereinafter be described. The PC of this Embodiment 3 may be realized by a configuration analogous to that of the aforementioned PC 100 of Embodiment 1. Accordingly, the analogous configurational elements are assigned with the identical symbols. The description thereof is omitted.

In a case where a handwriting input is started in a region of an object (the face of a person) in the image displayed on the display unit 14, the aforementioned PC 100 of Embodiment 1 determines the starting of the comment input. Ina case where a handwriting input is started in the region of the object (the face of a person) in the image displayed on the display unit 14, the PC 100 of this Embodiment 3 also determines the starting of the comment input. If the first stroke of handwriting has at least a prescribed length, the PC 100 of this Embodiment 3 provides a comment determination region at the finishing position of the first stroke of handwriting. In a case where the handwriting input is started in the comment determination region, it is determined that the comment input to the object in the region including the starting position of the first stroke of handwriting is started.

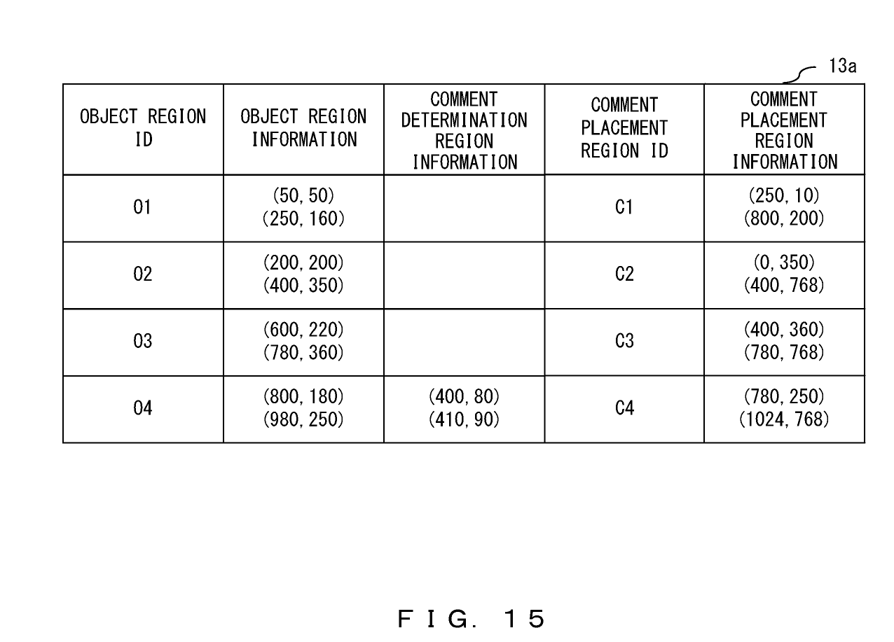

FIG. 15 is a schematic diagram illustrating stored contents of the detection region table 13a of Embodiment 3. As illustrated in FIG. 15, the detection region table 13a of this Embodiment 3 stores comment determination region information in addition to the object region ID, the object region information, the comment placement region ID and the comment placement region information. The comment determination region information is information indicating the comment determination region for determining whether a comment input to the corresponding object (object region) has been started or not. The top left and the bottom right points of each comment determination region are represented by coordinate values with respect to a prescribed reference position.

The reference position (0, 0) is, for instance, the top left point of a region displayable on the display unit 14. The coordinate values (x, y) of the top left and bottom right points of each comment determination region are represented regarding the right and the downward directions from the reference position (0, 0) as the x and y coordinate axes, respectively. In this Embodiment 3, if the first stroke of handwriting has at least a prescribed length when the user starts a handwriting input in the object region, the comment determination region information to be stored in the detection region table 13a is calculated and stored by the controller 10.

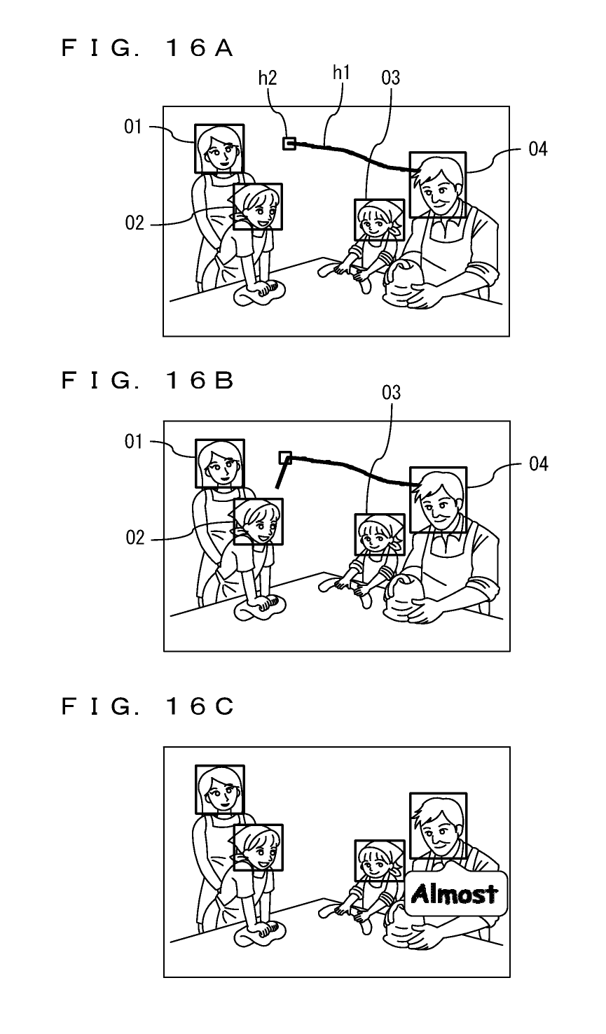

Functions realized by the PC 100 of this Embodiment 3 will hereinafter be described. The controller 10 of the PC 100 of this Embodiment 3 realizes the functions illustrated in FIGS. 3 and 4 by executing the control program stored in the ROM 11 or the storage 13. FIG. 16 is a schematic diagram for illustrating processes executed by the PC 100 of Embodiment 3.

The input status determination unit 6 in this Embodiment 3 determines whether the coordinate values of the starting position of the first stroke of handwriting input from the handwriting input acceptance unit 5 are included in any one of the object regions indicated by the object region information stored in the detection region table 13a, as with the input status determination unit 6 of the aforementioned Embodiment 1. In a case where the starting position of the first stroke is not included in anyone of the object regions, the input status determination unit 6 determines that the started handwriting input is a normal input and does not execute any process.

On the other hand, in a case where the starting position of the first stroke is included in any one of object regions, the input status determination unit 6 identifies which object region the position is included in, and determines that the started handwriting input is a comment input. At this time, the input status determination unit (discrimination unit) 6 determines whether the first stroke of handwriting input from the handwriting input acceptance unit 5 has at least a prescribed length or not. If the input status determination unit 6 determines that the first stroke of handwriting is shorter than the prescribed length, the input status determination unit 6 sets the comment input status as with the aforementioned Embodiment 1 and the PC 100 executes the comment process on the handwriting started from the first stroke.

On the other hand, in a case where the input status determination unit 6 of this Embodiment 3 determines that the first stroke of handwriting has at least the prescribed length, the input status determination unit 6 calculates the comment determination region to be displayed at the finishing position of the first stroke of handwriting. More specifically, the input status determination unit 6 calculates the comment determination region having a prescribed size (e.g. 10 pixels×10 pixels) centered at the finishing position of the first stroke of handwriting. The input status determination unit 6 associates the comment determination region information indicating the calculated comment determination region with the object region ID of the object region including the starting position of the first stroke and stores the associated information in the detection region table 13a.

The input status determination unit 6 transmits the comment determination region information stored in the detection region table 13a to the display processor 4. In a case where the object region display unit (determination region display unit) 42 of the display processor 4 acquires the comment determination region information from the input status determination unit 6, the object region display unit 42 displays the frame surrounding the comment determination region on the display unit 14 on the basis of the acquired comment determination region information. FIG. 16 (a) illustrates an example where a frame surrounding a comment determination region is displayed by the object region display unit 42 on the image. As illustrated in FIG. 16 (a), in a case where a handwriting h1 having at least a prescribed length is input from the object region O4, the PC 100 displays a comment determination region h2 at the finishing position of the handwriting h1.

After the comment determination region h2 as depicted in FIG. 16 (a) is displayed on the display unit 14, the input status determination unit (monitoring unit) 6 of this Embodiment 3 determines whether the coordinate values of the starting position of the input first stroke of handwriting are included in any one of the comment determination regions or not. More specifically, the input status determination unit 6 determines whether the coordinate values of the starting position are included in any one of the comment determination regions indicated by the comment determination region information stored in the detection region table 13a or not. The first stroke of handwriting may be a handwriting input next to the handwriting h1 having at least the prescribed length, or handwriting to be input after a comment input to another object or an input of drawing to the image.

In a case where the starting position of the first stroke input after the comment determination region h2 is displayed is included in any one of the comment determination regions, the input status determination unit 6 identifies which comment determination region the starting position is included in. The input status determination unit 6 identifies the object region corresponding to the identified comment determination region on the basis of the stored contents in the detection region table 13a, determines that the started handwriting input is a comment input to the identified object region, and sets the comment input status. In this case, the PC 100 executes the comment process on the handwriting input (handwriting) started at the comment determination region.

FIG. 16 (b) illustrates an example where a character “A” is started to be written in the comment determination region h2. Accordingly, in a situation illustrated in FIG. 16 (b), the input illustrated determination unit 6 determines that a comment input to the object region O4 has been started and sets the comment input status. In a case of setting the comment input status, the input status determination unit 6 starts storing of coordinate values (information indicating the comment-equivalent handwriting) acquired from the handwriting input acceptance unit 5 in the comment-equivalent handwriting buffer.

In a case where the input status determination unit 6 sets the comment input status, the input status determination unit 6 identifies which object region the started handwriting input is input to as a comment and reads the object region ID indicating the identified object region from the detection region table 13a. The input status determination unit 6 stores the read object region ID in the object buffer.

Thus, in this Embodiment 3, even in a case of a comment input to the object included in an edge region in the image, the size of the region to which handwriting is input is not limited. Accordingly, for instance, in a case of inputting a comment in a horizontal line to the right to the person imaged in the right edge region in the image, the effect of Embodiment 3 can prevent a region for handwriting input from narrowing.

The units other than the input status determination unit 6 and the object region display unit 42 of this Embodiment execute processes similar to those described in the aforementioned Embodiment 1. In the PC 100 of this Embodiment 3, in a case where “Almost” is input from the comment determination region h2 corresponding to the object region O4 as illustrated in FIG. 16 (b), “Almost” is displayed on the comment region corresponding to the object region O4 as illustrated in FIG. 16 (c).

In the PC 100 of this Embodiment 3, the processing executed by the controller 10 in a case where the user performs a prescribed operation for starting the edit process on the image is similar to that described in FIG. 7 of the aforementioned Embodiment 1.

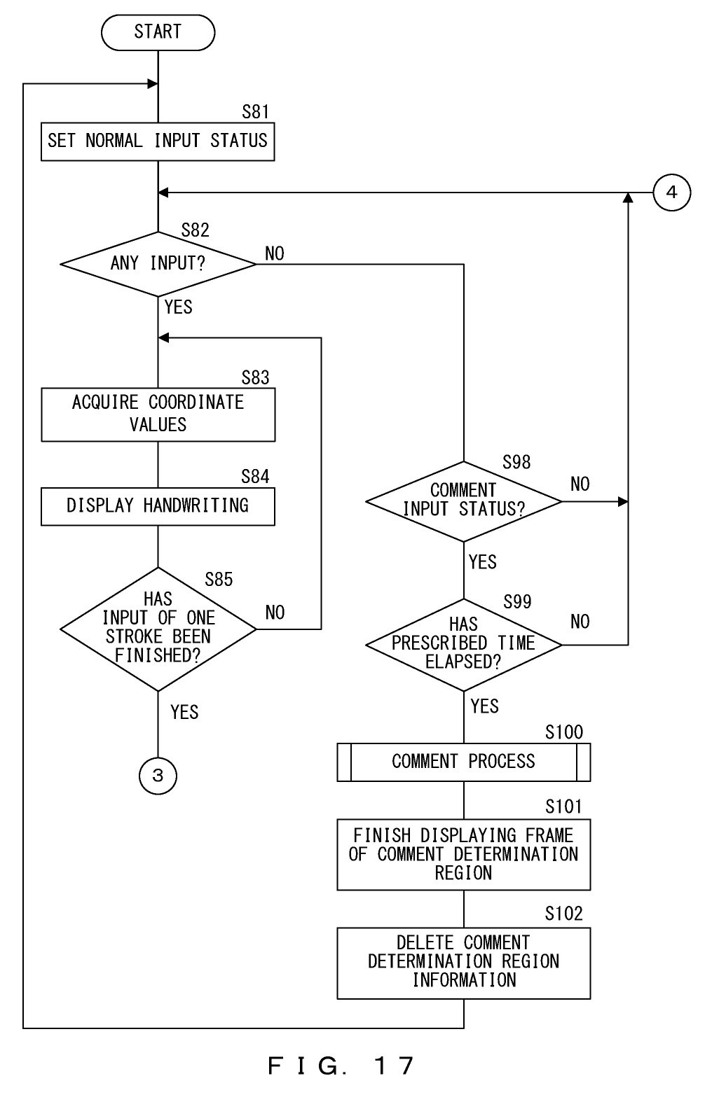

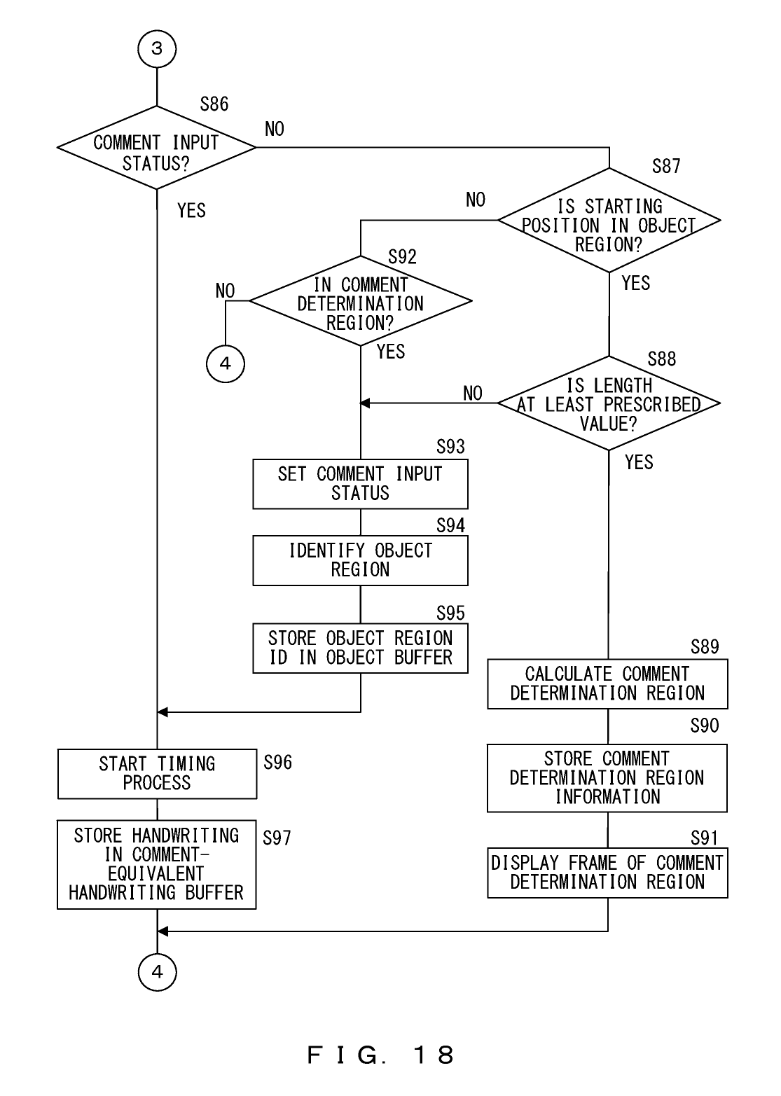

Next, in the PC 100 of this Embodiment 3, the process executed by the controller 10 in a case where the user starts a handwriting input to the image where the image and the frames surrounding the respective object regions are displayed will be described on the basis of flowcharts. FIGS. 17 and 18 are flowcharts illustrating procedures of processes executed by the PC 100 of Embodiment 3. The following processes are executed by the controller 10 according to a control program stored in the ROM 11 or the storage 13 of the PC 100.

In the PC 100 of this Embodiment 3, the processes in steps S81 to S87 of FIGS. 17 and 18 are similar to those in steps S21 to S27 of FIGS. 8 and 9 described in the aforementioned Embodiment 1.

The controller 10 determines whether the starting position of the input first stroke of handwriting is included in any one of the object regions indicated by the object region information stored in the detection region table 13a or not (S87). If the controller 10 determines that the starting position of the first stroke is included in any one of the object regions (S87: YES), the controller 10 determines whether the first stroke of handwriting has at least a prescribed value or not (S88).

If the controller 10 determines that the first stroke of handwriting has at least the prescribed length (S88: YES), the controller 10 calculates a comment determination region to be displayed at the finishing position of the first stroke of handwriting (S89). If the controller 10 determines that the first stroke of handwriting is shorter than the prescribed value (S88: NO), the controller 10 advances the process to step S93. The controller 10 associates the comment determination region information indicating the calculated comment determination region with the corresponding object region ID and stores the associated information in the detection region table 13a (S90).

The controller 10 displays the frame surrounding the comment determination region on the basis of the comment determination region information stored in the detection region table 13a (S91) and then returns the process to step S82. If the controller 10 determines that the starting position of the first stroke is not included in any one of the object regions (S87: NO), the controller 10 determines whether the starting position of the first stroke is included in any one of the comment determination regions indicated by the comment determination region information stored in the detection region table 13a or not (S92).

If the controller 10 determines that the starting position of the first stroke is not included any one of the comment determination regions (S92: NO), the controller 10 returns the process to step S82. If the controller 10 determines that the starting position of the first stroke is included in any one of the comment determination regions (S92: YES), the controller 10 determines that the started handwriting input is a comment input, and sets the comment input status (S93).

The controller 10 identifies the object region identified in step S87 to include the starting position of the first stroke, or the object region corresponding to the comment determination region identified in step S92 to include the starting position of the first stroke (S94). The controller 10 reads the object region ID of the identified object region from the detection region table 13a, and stores the read object region ID in the object buffer (S95).

The controller 10 starts a process of timing a prescribed time (e.g. 10 seconds) (S96). The timing process here is a process for determining whether or not the user has finished the comment input after the first stroke of handwriting was input. That is, in a case where the proscribed time has elapsed after the input of the first stroke of handwriting, the controller 10 determines that the user has finished the comment input.

The controller 10 stores the coordinate values indicating the one stroke of handwriting acquired in step S83 in the comment-equivalent handwriting buffer (S97). The controller 10 returns the process to step S82, and determines whether the next one stroke of handwriting is input via handwriting by the user or not (S82). If the controller 10 determines that the next one stroke of handwriting is input (S82: YES), the controller 10 repeats the processes in steps S83 to S85 and temporarily stores the coordinate values of points indicating the next one stroke of handwriting in the RAM 12.

After the input of the one stroke of handwriting is finished, the controller 10 determines whether or not the comment input status is set at this time (S86). If the controller 10 determines that the comment input status is set (S86: YES), the controller 10 restarts the process of timing the prescribed time (e.g. 10 seconds) (S96). The controller 10 stores the coordinate values indicating the one stroke of handwriting acquired in step S83 in the comment-equivalent handwriting buffer (S97).

The controller 10 returns the process to step S82, and determines whether the next one stroke of handwriting is input via handwriting by the user or not (S82). The controller 10 repeats the processes in steps S82 to S97 until the next one stroke of handwriting via handwriting by the user is broke. If the controller 10 determines that the next one stroke of handwriting is not to be input by the user (S82: NO), the controller 10 determines whether or not the comment input status is set at this time (S98).

If the controller 10 determines that the comment input status is set (S98: YES), the controller 10 determines whether the prescribed time has elapsed or not on the basis of the result of the timing process started in step S96 (S99). If the controller 10 determines that the comment input status is not set (S98: NO) or determines that the prescribed time has not elapsed yet (S99: NO), the controller 10 returns the process to step S82.

When the controller 10 determines that the prescribed time has elapsed (S99: YES), the controller 10 determines that the user has finished the comment input and executes the comment process (S100). After the controller 10 executes the comment process, the controller 10 finishes the display of the frames surrounding the respective comment determination regions displayed in step S91 (S101). The controller 10 deletes the comment determination region information stored in the detection region table 13a in step S90 (S102), and returns the process to step S81.

In the PC 100 of this Embodiment 3, the comment process executed by the controller 10 is similar to that illustrated in FIG. 10 of the aforementioned Embodiment 1.

As described above, in the PC 100 of Embodiment 3, in a case where the first stroke of handwriting input via handwriting started in the frame surrounding the object region displayed on the display unit 14 has at least the prescribed length, the frame indicating the comment determination region is displayed at the finishing position of the first stroke of handwriting. In a case where the handwriting input is started in the displayed comment determination region, the controller 10 determines that the comment input to the object corresponding to the object region of the starting position of the first stroke of handwriting having at least the prescribed length has started.

Thus, in a case where the user wishes to input a comment using a wide region, the user may extend the first stroke of handwriting to be at least the prescribed length from a desired object region to a position at which the user wishes to start the comment input. This allows a handwriting input from a desired position even in a case of a comment input to a person imaged at the edge of the image. Accordingly, the size of a region for handwriting input is not limited.

This Embodiment 3 has been described as a variation of the aforementioned Embodiment 1. However, Embodiment 3 is also applicable to the configuration of the aforementioned Embodiment 2.

### Embodiment 4

A PC according to Embodiment 4 will hereinafter be described. The PC of this Embodiment 4 may be realized by a configuration analogous to that of the PC 100 of the aforementioned Embodiment 3. Accordingly, analogous configurational elements are assigned with the identical symbols.

In a case where a handwriting input is started in a region of an object (the face of a person) in the image displayed on the display unit 14, if the first stroke of handwriting has at least a prescribed length, the PC 100 of the aforementioned Embodiment 3 provides a comment determination region at the finishing position of the first stroke of handwriting. In a case where a handwriting input is started in the comment determination region, the PC 100 then determines that the comment input has started to the object in a region including the starting position of the first stroke of the handwriting.

In a case where a handwriting input is started in an object region in the image displayed on the display unit 14, if the first stroke of handwriting has at least a prescribed length, the PC 100 of Embodiment 4 also provides a comment determination region at the finishing position of the first stroke of handwriting. After the comment determination region is displayed, if a handwriting input is not started in the comment determination region in a prescribed time, the PC 100 of this Embodiment 4 finishes displaying the comment determination region. After the PC 100 finishes the display of the comment determination region, the PC 100 does not execute comment processing on the handwriting input started in the comment determination region.

Functions realized by the PC 100 of this Embodiment 4 will hereinafter be described. The controller 10 of the PC 100 of this Embodiment 4 realizes the functions illustrated in FIGS. 3 and 4 by executing the control program stored in the ROM 11 or the storage 13.

As with the input status determination unit 6 of the aforementioned Embodiment 3, the input status determination unit 6 of Embodiment 4 determines whether or not the coordinate values of the starting position of the first stroke of handwriting input from the handwriting input acceptance unit 5 is included in any one of the object regions indicated by the object region information stored in the detection region table 13a. In a case where the starting position of the first stroke is not included in anyone of the object regions, the input status determination unit 6 determines that the started handwriting input is a normal input and does not execute any process.

On the other hand, the starting position of the first stroke is included in any one of the object regions, the input status determination unit 6 identifies which object region the position is included in and determines that the started handwriting input is a comment input. The input status determination unit 6 determines whether the first stroke of handwriting started in any one of the object regions has a prescribed length or not. If the input status determination unit 6 determines that the first stroke of handwriting is shorter than the prescribed length, the input status determination unit 6 sets the comment input status and the PC 100 executes the comment process on the handwriting started from the first stroke.

On the other hand, if the input status determination unit 6 determines that the first stroke of handwriting has at least the prescribed length, the input status determination unit 6 calculates a comment determination region to be displayed at the finishing position of the first stroke of handwriting. The input status determination unit 6 associates the comment determination region information indicating the calculated comment determination region with the object region ID of the object region including the starting position of the first stroke and stores the associated information in the detection region table 13a. The input status determination unit 6 transmits the comment determination region information stored in the detection region table 13a to the display processor 4. The object region display unit 42 of the display processor 4 displays the frame surrounding the comment determination region on the image displayed on the display unit 14 on the basis of the comment determination region information acquired from the input status determination unit 6.

Here, when the input status determination unit 6 of Embodiment 4 calculates the comment determination region and, transmits the comment determination region information indicating the calculated comment determination region to the display processor 4, the input status determination unit 6 starts a process of timing a second prescribed time (e.g. 10 seconds). The timing process here is a process for determining whether, after the frame surrounding the comment determination region is displayed, the user has started a handwriting input in the comment determination region or not. That is, in a case where there is no handwriting input started in the comment determination region until the second prescribed time has elapsed after the display of the frame surrounding the comment determination region, the controller 10 determines that the user has finished the comment input to the object corresponding to the comment determination region.

After the frame surrounding the comment determination region is displayed on the display unit 14, the input status determination unit 6 of Embodiment 4 determines whether or not the coordinate values of the starting position of the first stroke of handwriting are included in any one of the comment determination regions. In a case where the starting position of the first stroke input after the display of the frame surrounding the comment determination region is included in any one of the comment determination regions, the input status determination unit 6 determines that which comment determination region the position is included in. The input status determination unit 6 determines the object region corresponding to the identified comment determination region on the basis of the stored contents of the detection region table 13a, determines that the started handwriting input is a comment input to the identified object region and sets the comment input status. In this case, the PC 100 executes the comment process on the handwriting input (handwriting) started in the comment determination region.

In a case of setting the comment input status, the input status determination unit 6 identifies which object region the started handwriting input is input to as a comment, and reads the object region ID indicating the identified object region from the detection region table 13a. The input status determination unit 6 stores the read object region ID in the object buffer.

Thus, in Embodiment 4, the first stroke of handwriting having at least the prescribed length is input from any one of the object regions, allowing the region to be secured widely for comment input to the corresponding object (object region). After the comment determination region is displayed, in a case where the handwriting input is not started in the comment determination region in the prescribed time, the display of the frame surrounding the comment determination region is finished and the comment input to the corresponding object is finished. Thus, the display of the frame of a comment determination region is appropriately finished, thereby allowing display of an image easy for the user to watch.

The units of this Embodiment 4 other than the input status determination unit 6 execute processes similar to those described in the aforementioned Embodiments 1 and 3.

In the PC 100 of this Embodiment 4, the processing executed by the controller 10 in a case where the user performs a prescribed operation for starting the edit process on the image is similar to the processing illustrated in FIG. 7 of the aforementioned Embodiment 1.

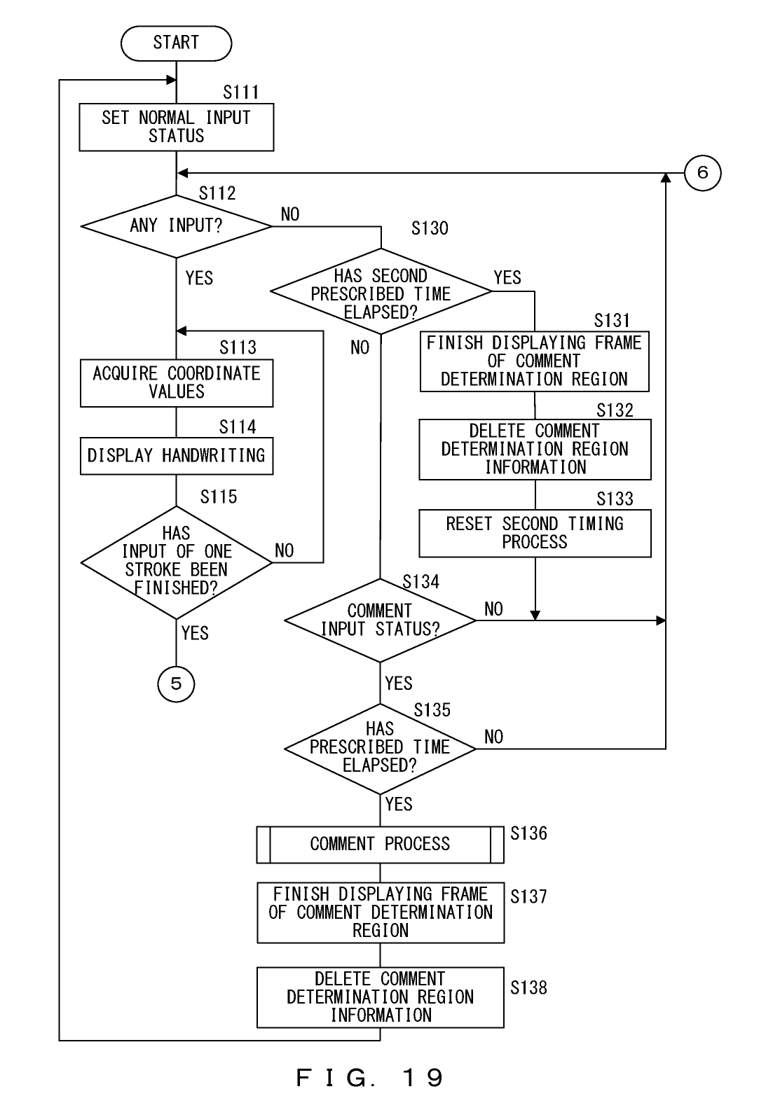

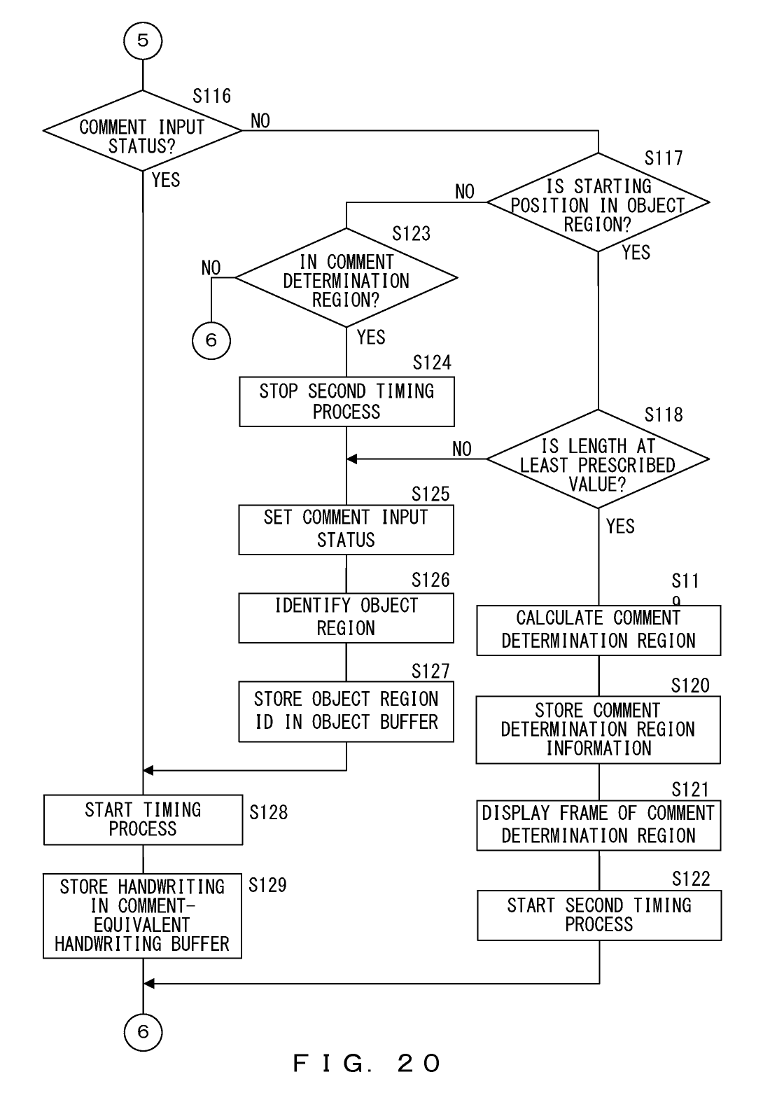

Next, in the PC 100 of Embodiment 4, processes executed by the controller 10 in a case where the user starts a handwriting input to an image on which an image and frames surrounding respective object regions are displayed will be described on the basis of flowcharts. FIGS. 19 and 20 are flowcharts illustrating procedures executed by the PC 100 of Embodiment 4. The following processes are executed by the controller 10 according to a control program stored in the ROM 11 or the storage 13 of the PC 100.

In the PC 100 of this Embodiment 4, processes of steps S111 to S121 in FIGS. 19 and 20 are similar to those in steps S81 to S91 in FIGS. 17 and 18 described in the aforementioned Embodiment 3. If the controller 10 in Embodiment 4 determines that the first stroke of handwriting is shorter than the prescribed value in step S118 (S118: NO), the controller advances the process to step S125.

The controller 10 of Embodiment 4 displays the frames surrounding the respective comment determination regions on the basis of the comment determination region information stored in the detection region table 13a (S121), subsequently starts the process of timing the second prescribed time (S122), and returns the process to step S112.

In step S117, if the controller 10 determines that the starting position of the first stroke is not included in any one of the object regions (S117: NO), the controller 10 determines whether or not the starting position of the first stroke is included in any one of the comment determination regions indicated by the comment determination region information stored in the detection region table 13a (S123). If the controller 10 determines that the starting position of the first stroke is not included in any one of the comment determination regions (S123: NO), the controller 10 returns the process to step S112.

If the controller 10 determines that the starting position of the first stroke is included in any one of the comment determination regions (S123: YES), the controller 10 stops the timing process started in step S122 (S124). The controller 10 then determines that the started handwriting input is a comment input, and sets the comment input status (S125).

The controller 10 identifies the object region determined to include the starting position of the first stroke in step S117 or the object region corresponding to the comment determination region determined to include the starting position of the first stroke in step S123 (S126). The controller 10 reads the object region ID of the identified object region from the detection region table 13a, and stores the read object region ID in the object buffer (S127).

The controller 10 starts a process of timing the prescribed time (e.g. 10 seconds) (S128). The timing process here is a process for determining whether, after input of one stroke of handwriting, the user has finished the comment input or not. That is, in a case where the prescribed time has elapsed after the input of the one stroke of handwriting, the controller 10 determines that the user has finished the comment input.

The controller 10 stores the coordinate values representing the one stroke of handwriting acquired in step S113 in the comment-equivalent handwriting buffer (S129). The controller 10 returns the process to step S112 and determines whether there is the next one stroke of handwriting via handwriting by the user or not (S112). If the controller 10 determines that there is the next one stroke of handwriting (S112: YES), the controller 10 repeats the processes in steps S113 to S115 and temporarily stores the coordinate values of points representing the next one stroke of handwriting in the RAM 12.

After the input of the one stroke of handwriting is finished, the controller 10 determines whether or not the comment input status is set at this time (S116). If the controller 10 determines that the comment input status is set (S116: YES), the controller 10 restarts the process of timing the prescribed time (e.g. 10 seconds) (S128). The controller 10 stores the coordinate values indicating the one stroke of handwriting acquired in step S113 in the comment-equivalent handwriting buffer (S129).

The controller 10 returns the process to step S112, and determines whether there is an input of the next one stroke of handwriting input via handwriting by the user or not (S112). The controller 10 repeats the processes in steps S112 to S129 until the next one stroke of handwriting via handwriting by the user is broke. If the controller 10 determines that there is not the next one stroke of handwriting via handwriting by the user (S112: NO), the controller 10 determines whether or not the second prescribed time has elapsed or not on the basis of the second timing process started in step S122 (S130).

If the controller 10 determines that the second prescribed time has elapsed (S130: YES), the controller 10 finishes the display of the frame surrounding the comment determination region displayed in step S121 (S131). At this time, the controller 10 also finishes the display of the first stroke of handwriting extended from the object region to display the frame surrounding the comment determination region. The controller 10 deletes from the detection region table 13a the comment determination region information indicating the comment determination region whose display has been finished (S132). The controller 10 resets the process of timing the second prescribed time (S133) and returns the process to step S112.

If the controller 10 determines that the second prescribed time has not elapsed yet (S130: NO), the controller 10 determines whether or not the comment input status is set at this time (S134). If the controller 10 determines that the comment input status is set (S134: YES), the controller 10 determines whether the prescribed time has elapsed or not on the basis of the result of the timing process started in step S128 (S135). If the controller 10 determines that the comment input status is not set (S134: NO) or that the prescribed time has not elapsed yet (S135: NO), the controller 10 returns the process to step S112.

If the controller 10 determines that the prescribed time has elapsed (S135: YES), the controller 10 determines that the user has finished the comment input and executes the comment process (S136). After executing the comment process, the controller 10 finishes the display of the frame surrounding the comment determination region displayed in step S121 (S137). At this time, the controller 10 also finishes the display of the first stroke of handwriting extended from the object region to display the frame surrounding the comment determination region. The controller 10 deletes the comment determination region information stored in the detection region table 13a in step S120 (S138) and returns the process to step S111.

In the PC 100 of Embodiment 4, the comment process executed by the controller 10 is similar to that illustrated in FIG. 10 of the aforementioned Embodiment 1.

As described above, in a case where the first stroke of handwriting of the handwriting input started in the frame surrounding the object region displayed on the display unit 14 has at least the prescribed length, the PC 100 of Embodiment 4 displays the frame indicating the comment determination region at the finishing position of the first stroke of handwriting. In a case where a handwriting input has been started in the displayed comment determination region, the PC 100 determines that a comment input to the object corresponding to the object region of the starting position of the first stroke of handwriting having at least the prescribed length has been started. In a case where, after the display of the comment determination region, the handwriting input is not started in the comment determination region in the prescribed time, the PC 100 finishes the display of the frame indicating the comment determination region and finishes the comment input to the corresponding object.

Accordingly, the region for comment input to the object may widely be secured, and an image easy for the user to watch may be displayed by appropriately finishing the display of the frame of a comment determination region.

This Embodiment 4 has been described as a variation of the aforementioned Embodiments 1 and 3. However, Embodiment 4 is applicable to the configuration of the aforementioned Embodiment 2.

### Embodiment 5

A PC according to Embodiment 5 will hereinafter be described. The PC of this Embodiment 5 may be realized by a configuration analogous to the aforementioned PC 100 of Embodiment 1. Accordingly, the analogous configurational elements are assigned with the identical symbols.

In a case where a handwriting input has been started in a region of an object (the face of a person) in the image displayed on the display unit 14, the PC 100 of the aforementioned Embodiment 1 determines that the comment input has been started and executes the comment process on the handwriting input via handwriting. If the PC 100 of this Embodiment 5 determines that the comment input has been started, the PC 100 executes a character string recognition process on the handwriting input via handwriting. If the PC 100 of this Embodiment 5 determines that the input handwriting is a character string according to the result of the character string recognition process, the PC 100 executes the comment process on the input handwriting.

Although it is not depicted, the PC 100 of Embodiment 5 stores in the storage 13 a dictionary for character string recognition for using the character string recognition process in addition to the hardware units depicted in FIG. 1. In the dictionary for character string recognition, as to each of the character strings, a dictionary including handwriting information representing each stroke of each character as coordinate values of points with a prescribed spacing and a dictionary including a word dictionary or information on connectability between characters are registered.

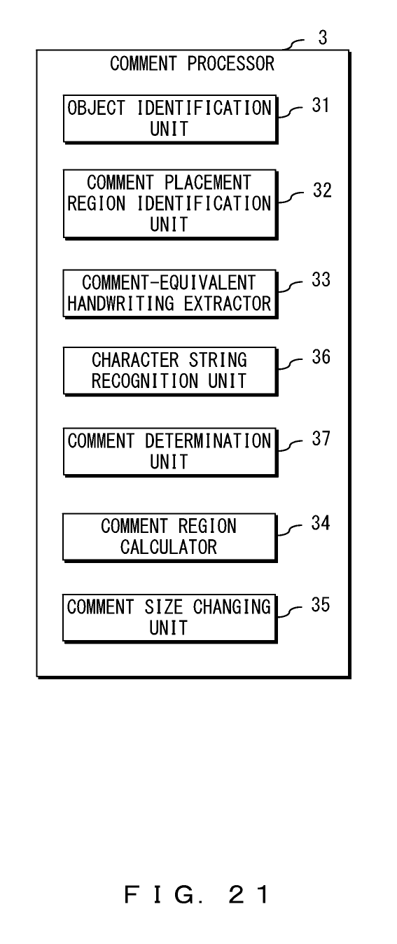

Functions realized by the PC 100 of this Embodiment 5 will hereinafter be described. The controller 10 of the PC 100 of Embodiment 5 realizes functions illustrated in FIG. 21 in addition to the functions illustrated in FIGS. 3 and 4 by executing a control program stored in the ROM 11 or the storage 13. FIG. 21 is a functional block diagram illustrating the functions included in the comment processor 3 of the Embodiment 5.

The comment processor 3 of Embodiment 5 includes a character string recognition unit 36 and a comment determination unit 37 in addition to the units illustrated in FIG. 4.

In a case of being notified that the comment input has been finished from the input status determination unit 6, the comment-equivalent handwriting extractor 33 of this Embodiment 5 reads the coordinate values stored in the comment-equivalent handwriting buffer as with the comment-equivalent handwriting extractor 33 of the aforementioned Embodiment 1. The comment-equivalent handwriting extractor 33 transmits the read coordinate values (information representing the comment-equivalent handwriting) to the character string recognition unit 36.

The character string recognition unit 36 executes the character string recognition process based on the dictionary for character string recognition on the coordinate values (information representing the comment-equivalent handwriting) acquired from the comment-equivalent handwriting extractor 33. More specifically, the character string recognition unit 36 compares each character string registered in the dictionary for character string recognition with the comment-equivalent handwriting, identifies a character string most resembling the comment-equivalent handwriting, and calculates reliability representing a degree of resemblance between the identified character string and the comment-equivalent handwriting.

The character string recognition unit 36 transmits the calculated reliability and the information representing the comment-equivalent handwriting acquired from the comment-equivalent handwriting extractor 33 to the comment determination unit 37. The comment determination unit (character string determination unit) 37 determines whether the comment-equivalent handwriting acquired from the comment-equivalent handwriting extractor 33 is a character string or not on the basis of the reliability acquired from the character string recognition unit 36. More specifically, the comment determination unit 37 determines whether the reliability is at least a prescribed value (e.g. 80, 90 or the like in a case where the maximum value is 100) or not. If the reliability is at least a prescribed value, the comment determination unit 37 transmits the information representing the comment-equivalent handwriting acquired from the character string recognition unit 36 to the comment region calculator 34.

If the reliability is less than the prescribed value, the comment determination unit 37 does not execute anything, and the PC 100 does not executes the comment process on the handwriting input via handwriting. That is, even if the input is a handwriting input started in the object region, in a case where the input handwriting is not a character string, the comment process is not executed on the input handwriting.

The comment region calculator 34 of Embodiment 5 acquires the information representing the comment-equivalent handwriting from the comment determination unit 37. The comment region calculator 34 detects the input comment region on the basis of the acquired information representing the comment-equivalent handwriting, and calculates the size changing ratio between the detected input comment region and the comment placement region, as with the comment region calculator 34 of the aforementioned Embodiment 1.

The comment region calculator 34 calculates the vertical and horizontal lengths of the comment region after being changed in size from the input comment region according to the calculated size changing ratio, and identifies the position of the comment region represented in the calculated lengths in the vertical and horizontal directions. The comment region calculator 34 calculates the coordinate values of the top left and bottom right points of the identified comment region, notifies the display processor 4 of the calculated values, and notifies the comment size changing unit 35 of the calculated size changing ratio.

Accordingly, in this Embodiment 5, even in a case where a handwriting input is started in the object region, if a drawing that is not a character or a character string is performed, the comment process is not executed but a process for a simple drawing is executed. Accordingly, even for the drawing started in the object region, the condition may be relaxed for determining that the input is a drawing not to be subjected to the comment process.

The units of this Embodiment 5 other than the character string recognition unit 36 and the comment determination unit 37 execute the processes similar to those described in the aforementioned Embodiment 1.

In the PC 100 of this Embodiment 5, processes executed by the controller 10 in the case where the user performs the prescribed operation for starting the edit process on the image are similar to those illustrated in FIG. 7 of the aforementioned Embodiment 1.

In the PC 100 of this Embodiment 5, processes executed by the controller 10 in a case where the user starts a handwriting input to an image on which an image and frames surrounding respective object regions are displayed are similar to those illustrated in FIGS. 8 and 9.

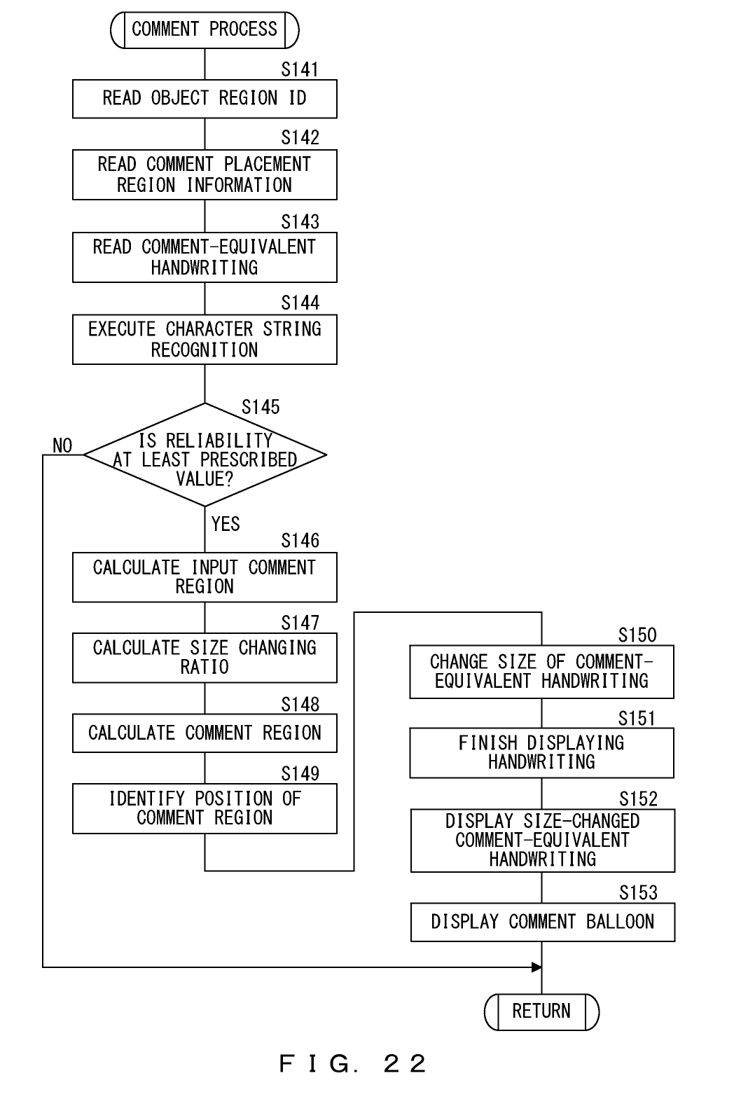

Next, the comment processing in the processes by the PC 100 of this Embodiment 5 will be described on the basis of flowcharts. FIG. 22 is a flowchart illustrating procedures of the comment process in Embodiment 5. The following process is executed by the controller 10 according to a control program stored in the ROM 11 or the storage 13 of the PC 100.

In the PC 100 of this Embodiment 5, processes insteps S141 to S143 in FIG. 22 are similar to those in steps S41 to S43 in FIG. 10 described in the aforementioned Embodiment 1.

The controller 10 executes character string recognition on the coordinate values read from the comment-equivalent handwriting buffer on the basis of the dictionary for character string recognition (S144). The controller 10 identifies the character string most resembling the comment-equivalent handwriting represented by the read coordinate values, and calculates the reliability between the identified character string and the comment-equivalent handwriting.

The controller 10 determines whether the calculated reliability is at least a prescribed value or not (S145). If the controller 10 determines the reliability is less than the prescribed value (S145: NO), the controller 10 finishes the comment process and returns the process to that illustrated in FIG. 8. If the controller determines that the reliability is at least the prescribed value (S145: YES), the controller 10 calculates a rectangular input comment region that includes a comment-equivalent handwriting and the area being the minimum on the basis of the coordinate values read from the comment-equivalent handwriting buffer (S146).

The following processes in steps S146 to S153 are similar to those in steps S44 to S51 in FIG. 10 described in the aforementioned Embodiment 1.

As described above, the PC 100 of this Embodiment 5 may designate whether the input is a comment input to a desired object (person) or a drawing operation at a desired position even if the handwriting input is started from a desired position in the image displayed on the display unit 14. Even in a case of starting the handwriting input in the object region, the PC 100 does not execute the comment process on the drawing that is not a character or a character string. This relaxes the condition of determining that the input is a drawing not to be subjected to the comment process.

This Embodiment 5 has been described as a variation of the aforementioned Embodiment 1. However, Embodiment 5 is also applicable to the configurations of the aforementioned Embodiments 2 to 4.

### Embodiment 6

A PC according to Embodiment 6 will hereinafter be described. The PC of this Embodiment 6 may be realized by a configuration similar to the PC 100 of the aforementioned Embodiment 5. Accordingly, analogous configurational elements are assigned with the same symbols.

In a case where the PC 100 of the aforementioned Embodiment 5 determines that an input is a start of the comment input, the PC 100 executes the character string recognition process on the input handwriting. Then, in a case where the PC 100 determines that the input handwriting is a character string, the PC 100 executes the comment process on the input handwriting. If the PC 100 of this Embodiment 6 determines that the input handwriting is a character string, the PC 100 executes the comment process, which converts the input handwriting into text data and displays the converted data.

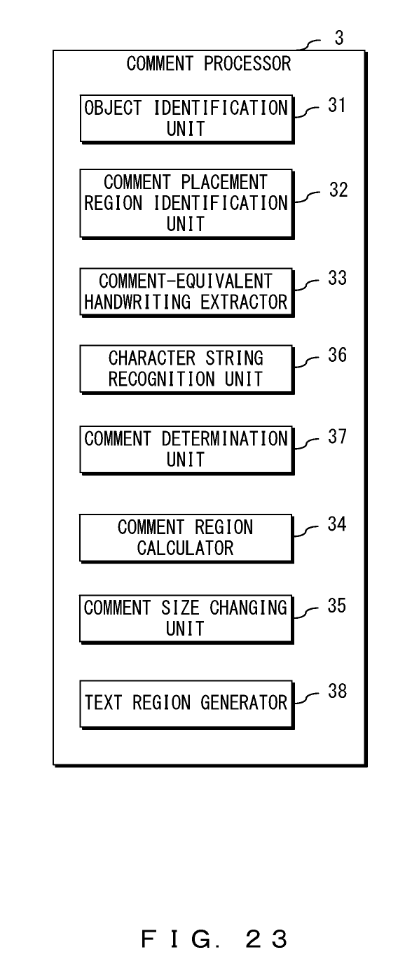

Functions realized by the PC 100 of this Embodiment 6 will hereinafter be described. The controller 10 of the PC 100 of this Embodiment 6 realizes the functions illustrated in FIG. 23 in addition to the functions illustrated in FIGS. 3 and 4 by executing a control program stored in the ROM 11 or the storage 13. FIG. 23 is a functional block diagram illustrating functions included in the comment processor 3 of Embodiment 6.

The comment processor 3 of this Embodiment 6 includes a text region generator 38 in addition to the units illustrated in FIG. 21.

The character string recognition unit 36 of this Embodiment 6 transmits to the comment determination unit 37 the character string identified to be the most resembling comment-equivalent handwriting and the reliability between the identified character string and the comment-equivalent handwriting. The comment determination unit 37 determines whether the reliability acquired from the character string recognition unit 36 is at least a prescribed value (e.g. 80, 90 or the like in a case where the maximum value is 100). If the reliability is at least the prescribed value, the comment determination unit 37 transmits the character string acquired from the character string recognition unit 36 to the comment region calculator 34.

If the reliability is less than the prescribed value, the comment determination unit 37 does not execute anything. The PC 100 does not execute comment process on the handwriting input via handwriting. That is, even if the input is a handwriting input started in the object region, in a case where the input handwriting is not a character string, the PC 100 does not execute the comment process on the input handwriting.

The comment region calculator 34 of this Embodiment 6 calculates the number of characters included in the character string acquired from the comment determination unit 37. The comment region calculator 34 calculates the size of a text box for displaying the character string acquired from the comment determination unit 37 with a prescribed font size on the basis of the calculated number of characters. The prescribed font size and font information is preliminarily stored, for instance, in the ROM 11 or the storage 13.

The comment region calculator 34 reads from the detection region table 13a the comment placement region information corresponding to the comment placement region ID notified from the comment placement region identification unit 32. The comment region calculator 34 determines whether or not the calculated text box can be accommodated in the comment placement region indicated by the comment placement region information read from the detection region table 13a on the basis of the calculated size of the text box.

If the comment region calculator 34 determines that the calculated text box can be accommodated in the comment placement region, the comment region calculator 34 determines the position of the calculated text box in the comment placement region. The comment region calculator 34 determines that the position that minimizes the distance from the object region as the position of the text box in the comment placement region. The comment region calculator 34 calculates the coordinate values of the top left and bottom right positions of the identified text box, and transmits the calculated coordinate values and the character string acquired from the comment determination unit 37 to the comment size changing unit 35.

If the comment region calculator 34 determines that the calculated text box cannot be accommodated in the comment placement region, the comment region calculator 34 regards the size of the text box as the size of the comment placement region. Accordingly, the comment region calculator 34 regards the comment placement region as the region of the text box, calculates the coordinate values of the top left and bottom right positions of the text box, and transmits the calculated coordinate values and the character string acquired from the comment determination unit 37 to the comment size changing unit 35.

The comment size changing unit 35 determines whether or not the character string acquired from the comment region calculator 34 can be displayed in the text box based on the coordinate values acquired from the comment region calculator 34 with the prescribed font size. If the comment size changing unit 35 determines that the character string is displayable in the text box, the comment size changing unit 35 transmits the coordinate values acquired from the comment region calculator 34, character string and the prescribed font size to the text region generator 38.

On the other hand, if the comment size changing unit 35 determines that the character string is not displayable in the text box, the comment size changing unit 35 calculates a font size displayable in the text box. The comment size changing unit 35 transmits the coordinate values acquired from the comment region calculator 34, the character string and the calculated font size to the text region generator 38.

The text region generator 38 generates a text box on the basis of the coordinate values acquired from the comment size changing unit 35, and displays the characters according to the character string acquired from the comment size changing unit 35 and the font size in the generated text box. The text region generator 38 transmits information of the text box in which the characters are displayed to the display processor 4.

The comment display unit 44 of the display processor 4 displays the text box, in which the characters are displayed with the prescribed font, on the image displayed on the display unit 14 on the basis of the information acquired from the text region generator 38. The comment balloon display unit 45 of this Embodiment 6 calculates a comment balloon corresponding to the size of the text box displayed by the comment display unit 44, and displays the comment balloon surrounding the text box.

Accordingly, in this Embodiment 6, even in a case where the handwriting input is started in the object region, if a drawing other than a character or a character string is performed, the comment process is not executed but the process for a simple drawing is executed. In this Embodiment 6, if the handwriting input via handwriting is a character or a character string, the input is converted into the text data and displayed. This is effective in a case where it is desired not to display the handwriting input via handwriting.

The units of this Embodiment 6 other than the comment region calculator 34, the comment size changing unit 35 and the text region generator 38 execute processes similar to those described in the aforementioned Embodiment 5.

In the PC 100 of this Embodiment 6, processes executed by the controller 10 in a case where the user performs a prescribed operation for starting the edit process on the image are similar to those illustrated in FIG. 7 of the aforementioned Embodiment 1.

In the PC 100 of this Embodiment 6, processes executed by the controller 10 in a case where the user starts the handwriting input to the image on which the image and the frame surrounding the object region are displayed are similar to those illustrated in FIGS. 8 and 9 in the aforementioned Embodiment 1.

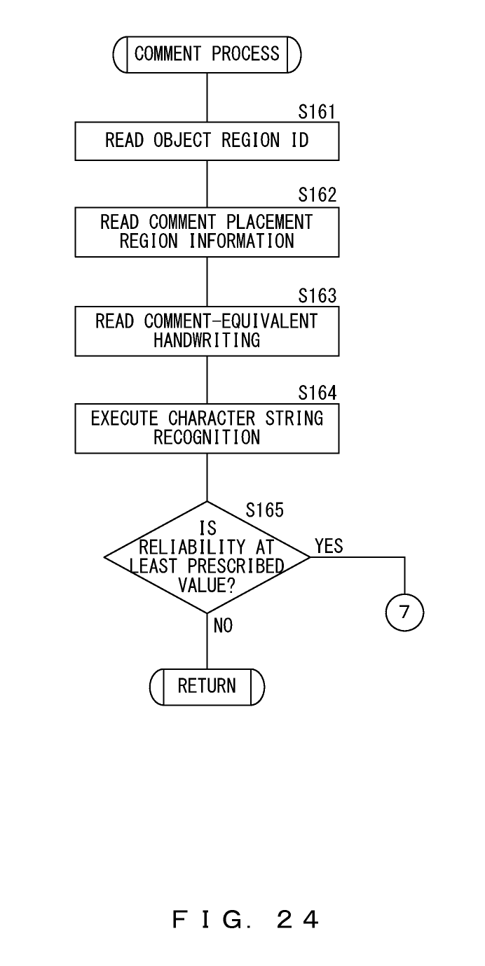

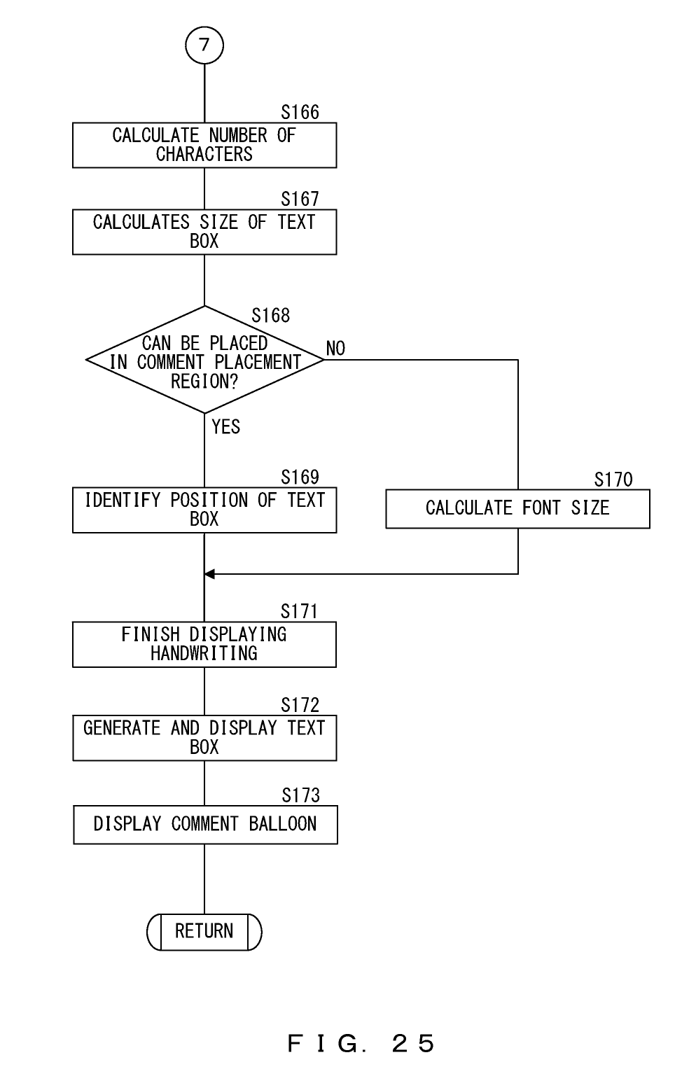

Next, the comment processing in the processes of the PC 100 of this Embodiment 6 will be described on the basis of flowcharts. FIGS. 24 and 25 are flowcharts illustrating procedures of the comment process of Embodiment 6. The following processes are executed by the controller 10 according to a control program stored in the ROM 11 or the storage 13 of the PC 100.

In the PC 100 of this Embodiment 6, processes in steps S161 to S165 in FIG. 24 are similar to those in steps S141 to S145 in FIG. 22 described in the aforementioned Embodiment 5.

In a case where the controller 10 determines that the reliability calculated by executing the character string recognition is at least the prescribed value (S165: YES), the controller 10 calculates the number of characters of the character string identified to be the most resembling the comment-equivalent handwriting according to the result of the character string recognition (S166). The controller 10 calculates the size of the text box for displaying the character string with a prescribed font size on the basis of the calculated number of characters (S167).

The controller 10 determines whether or not the text box whose size has been calculated in step S167 may be arranged in the comment placement region indicated by the comment placement region information read in step S162 (S168). If the controller 10 determines that the text box may be arranged in the comment placement region (S168: YES), the controller 10 identifies the position of the text box in the comment placement region (S169).

On the other hand, the controller 10 determines that the text box cannot be arranged in the comment placement region (S168: NO), the controller 10 regards the comment placement region as the region of the text box, and calculates the font size capable of displaying the character string acquired according to the result of the character string recognition in the text box (S170).

The controller 10 finishes the display of the handwriting displayed in step S24 in FIG. 8 (S171). The controller 10 generates a text box at the position identified in step S169 or a text box as a comment placement region, and displays the character string with the prescribed font size or the font size calculated in step S170 in the generated text box (S172).

The controller 10 displays the comment balloon corresponding to the text box displayed in step S172 (S173). The controller 10 finishes the aforementioned comment process and returns the process to that illustrated in FIG. 8.

As described above, in the PC 100 of this Embodiment 6, it can be designated whether the input is a comment input to a desired object (person) or a drawing operation at a desired position by starting a handwriting input at a desired position in the image displayed on the display unit 14. In a case where the handwriting input is started in the object region and a character or a character string is input, the input handwriting is converted into text data and displayed. Accordingly, even in a case where a scribbled character string is input via handwriting, the comment is displayed with the prescribed font.

This Embodiment 6 has been described as a variation of the aforementioned Embodiment 5. However, Embodiment 6 is applicable to the configurations of the aforementioned Embodiments 2 to 4.

### Embodiment 7

A PC according to Embodiment 7 will hereinafter be described. The PC of this Embodiment 7 may be realized by a configuration analogous to that of the aforementioned PC 100 of Embodiment 1. Accordingly, analogous configurational elements are assigned with the similar symbols.

In the PCs 100 of the aforementioned Embodiments 1 to 6, a drawing is performed at a desired position on the image displayed on the display unit 14 via handwriting input or a comment is added to a desired object in the image. The PC 100 of this Embodiment 7 has a function of changing a comment having already been added to the object, in addition to the aforementioned configuration.

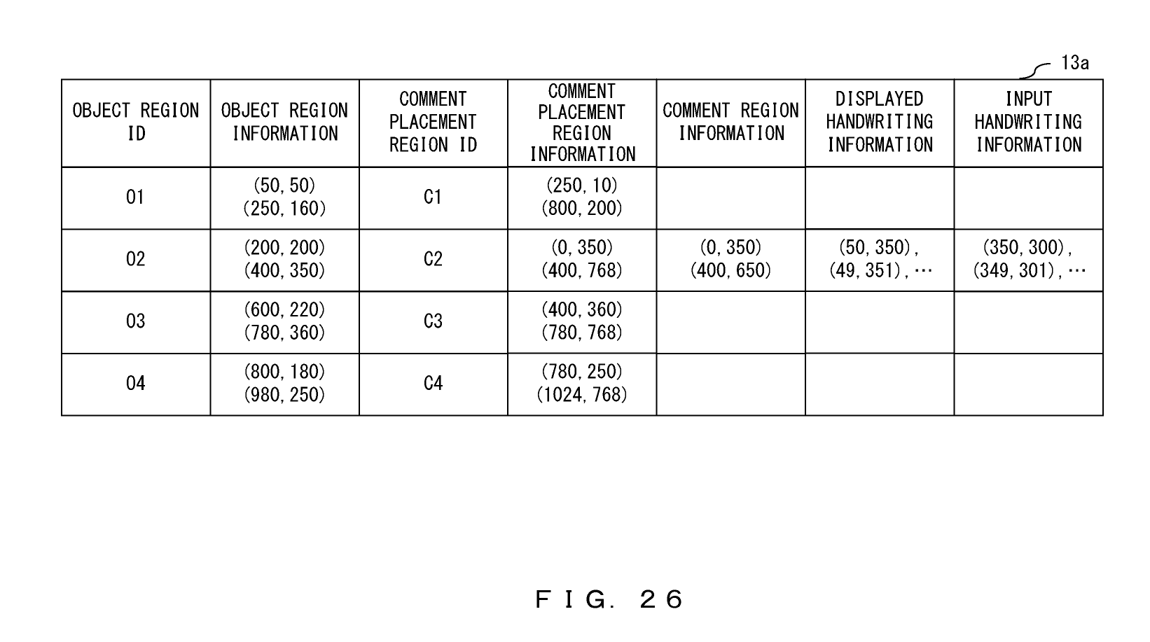

FIG. 26 is a schematic diagram illustrating stored contents of the detection region table 13a of Embodiment 7. As illustrated in FIG. 26, the detection region table (handwriting storing unit) 13a of this Embodiment 7 stores comment region information, displayed handwriting information and input handwriting information in addition to an object region ID, object region information, a comment placement region ID and comment placement region information. The comment region information is information indicating a comment region displayed with a comment balloon to each object (object region), and represents the top left and bottom right points of each comment region as coordinate values with respect to a prescribed reference position.

The reference position (0, 0) is, for instance, the point of the top left of a region displayable on the display unit 14. The coordinate values (x, y) of the top left and bottom right points of each comment determination region are represented regarding the right and downward directions from the reference position (0, 0) as the x and y coordinate axes, respectively. The displayed handwriting information is handwriting information indicating handwriting input via handwriting, subjected to the comment process by the controller 10 and displayed in each comment region. The input handwriting information is handwriting information representing the handwriting input via handwriting. The handwriting information represents coordinate values of points representing each piece of handwriting in coordinate values (x, y) with respect to a prescribed reference position (0, 0).

The comment region information, the displayed handwriting information and the input handwriting information stored in the detection region table 13a are stored by the controller 10 every time the controller 10 executes the comment process on the handwriting input via handwriting and displays the processed result on the display unit 14.

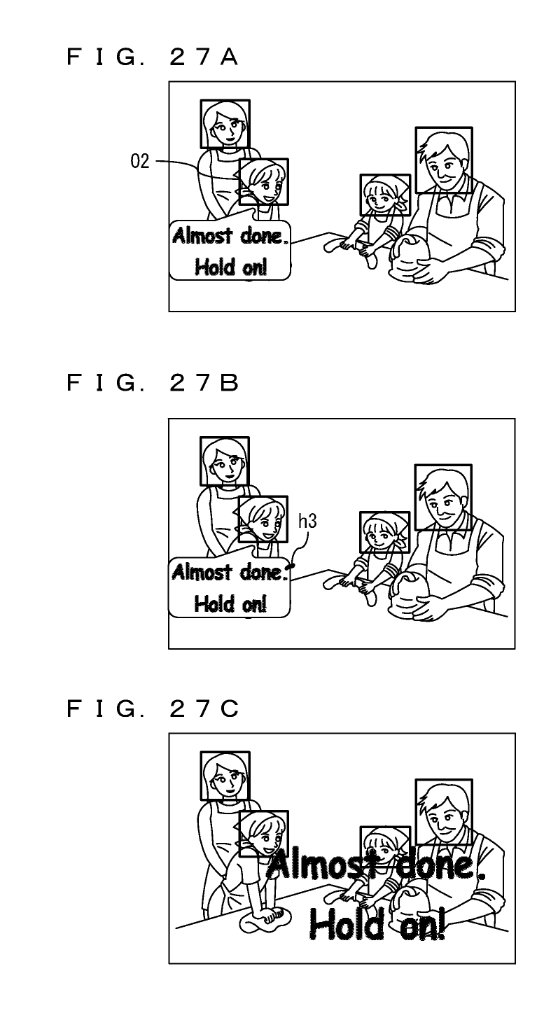

Functions realized by the PC 100 of this Embodiment 7 will hereinafter be described. The controller 10 of the PC 100 of this Embodiment 7 realizes the functions illustrated in FIGS. 3 and 4 by executing the control program stored in a ROM 11 or a storage 13. FIG. 27 is a schematic diagram for illustrating processes executed by the PC 100 of Embodiment 7.

The input status determination unit 6 of this Embodiment 7 determines whether or not the coordinate values of the starting position of the first stroke of handwriting input from the handwriting input acceptance unit 5 is included in any one of the object regions indicated by the object region information or the comment regions indicated by the comment region information stored in the detection region table 13a. If the input status determination unit 6 determines that the starting position of the first stroke is not included in any one of the object regions and the comment regions, the input status determination unit 6 determines that the started handwriting input is a normal input and does not execute any process.

If the input status determination unit 6 determines that the starting position of the first stroke of handwriting is included in any one of the object regions, the input status determination unit 6 identifies which object region the position is included in. The input status determination unit 6 then determines whether the comment region information corresponding to the object region ID of the identified object region is stored in the detection region table 13a or not. If the input status determination unit 6 determines that the corresponding comment region information is stored in the detection region table 13a, that is, in a case where comment information has already been added to the identified object region, the input status determination unit 6 does not execute any process.

On the other hand, if the input status determination unit 6 determines that the corresponding comment region information is not stored in the detection region table 13a, that is, in a case where comment information has not been added to the identified object region yet, the input status determination unit 6 determines that the started handwriting input is a comment input to the identified object region. At this time, the input status determination unit 6 executes the process similar to that described in the aforementioned Embodiment 1.

If the input status determination unit 6 determines that the starting position of the first stroke of handwriting is included in any one of the comment regions, the input status determination unit 6 determines whether the first stroke of handwriting has at least a prescribed length or not. If the input status determination unit 6 determines that the first stroke of handwriting has at least the prescribed length, the input status determination unit 6 determines that the started handwriting input is a normal input and does not execute any process.

If the input status determination unit 6 determines that the first stroke of handwriting started in the comment region is shorter than the prescribed length, the input status determination unit 6 determines that the started handwriting input is an instruction of editing (changing) the comment information displayed in the comment region including the starting position of the first stroke of handwriting. At this time, the input status determination unit 6 identifies which comment region the starting position of the first stroke of handwriting is included in, and sets the comment input status.

FIG. 27 (a) depicts an image in which comment information that is “Almost done. Hold on!” is added to an object region O2. FIG. 27 (b) depicts a state in which the first stroke of handwriting h3 is input via handwriting from the comment region of the object region O2 to the image illustrated in FIG. 27 (a). In a case where handwriting having a length shorter than the prescribed length is input in the comment region as illustrated in FIG. 27 (b), the user may change the comment information (handwriting information) displayed in the comment region by the PC 100 of this Embodiment 7.

If the input status determination unit 6 identifies the comment region including the starting position of the first stroke of handwriting, the input status determination unit 6 reads the comment placement region ID corresponding to the identified comment region from the detection region table 13a. The input status determination unit 6 stores the read comment placement region ID in an editing buffer. The input status determination unit 6 uses, for instance, a prescribed region in the RAM 12 for editing.

If the input status determination unit 6 of this Embodiment 7 determines that the input is an instruction of changing the comment information, the input status determination unit 6 stores the comment placement region ID read from the detection region table 13a in the editing buffer and subsequently notifies the comment processor 3 of this storing.

If the storing of the comment placement region ID in the editing buffer is notified, the object identification unit 31 of the comment processor 3 reads the comment placement region ID stored in the editing buffer. The object identification unit 31 reads the input handwriting information stored in the detection region table 13a in association with the read comment placement region ID and notifies the display processor 4 of the read information.

In the display processor 4 having acquired the input handwriting information from the object identification unit 31, the handwriting display unit (input handwriting display unit) 43 displays the handwriting (comment-equivalent handwriting) indicated by the acquired input handwriting information on the image displayed on the display unit 14. In a case where the handwriting display unit 43 displays the comment-equivalent handwriting on the display unit 14, the comment display unit 44 finishes the display of the comment information (comment-equivalent handwriting after size change) displayed in the comment region. In a case where the handwriting display unit 43 displays the comment-equivalent handwriting on the display unit 14, the comment balloon display unit 45 finishes the display of the comment balloon surrounding the comment region.

FIG. 27 (c) depicts an image in which display of the comment information and the comment balloon displayed on the comment region is finished and comment-equivalent handwriting previously input by the user via handwriting is displayed in a state of previously input by the user via handwriting. As illustrated in FIG. 27 (c), in a case where the comment information (comment-equivalent handwriting) previously input via handwriting is displayed, the user may edit the displayed comment information.

Although the edit process on the comment information (comment-equivalent handwriting) is not described in detail, a prescribed operation performed by the user enables one or entire pieces of the comment information displayed on the display unit 14 to be erased. This allows the process of changing the comment information having already been added to the object region in the image, in this Embodiment 7.

The units of this Embodiment 7 other than the input status determination unit 6, the object identification unit 31 and the handwriting display unit 43 execute processes similar to those described in the aforementioned Embodiment 1.

Processes of the PC 100 of this Embodiment 7 executed by the controller 10 in a case where the user performs a prescribed operation for starting the edit process on the image are similar to those illustrated in FIG. 7 in the aforementioned Embodiment 1.

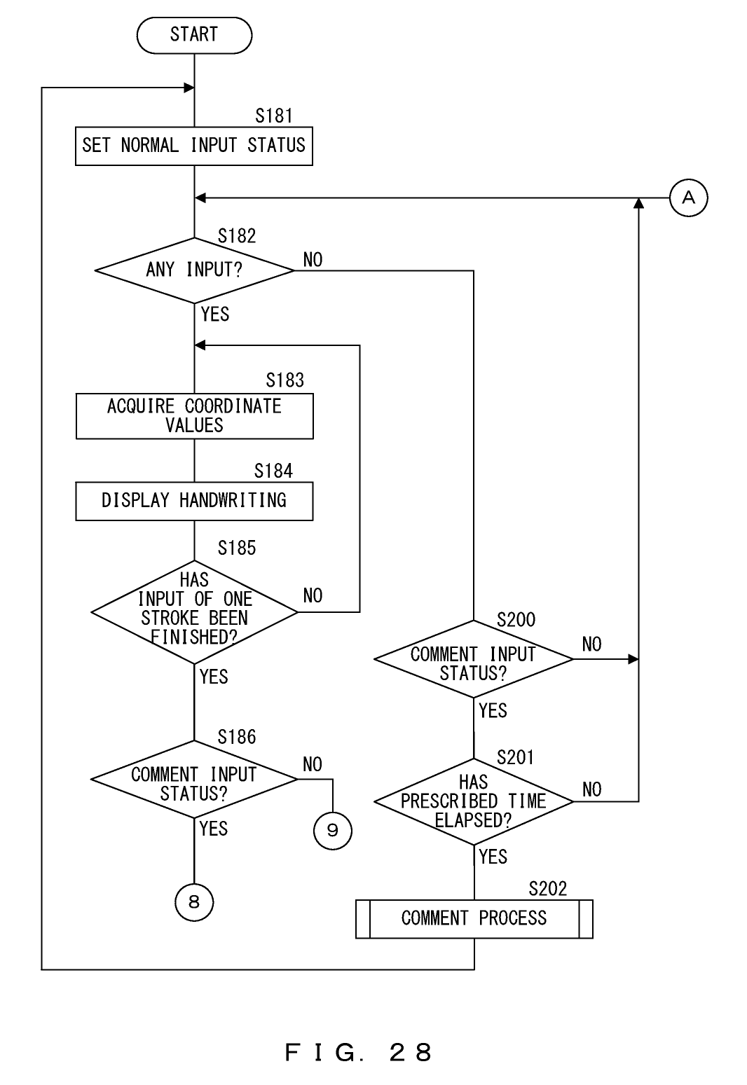

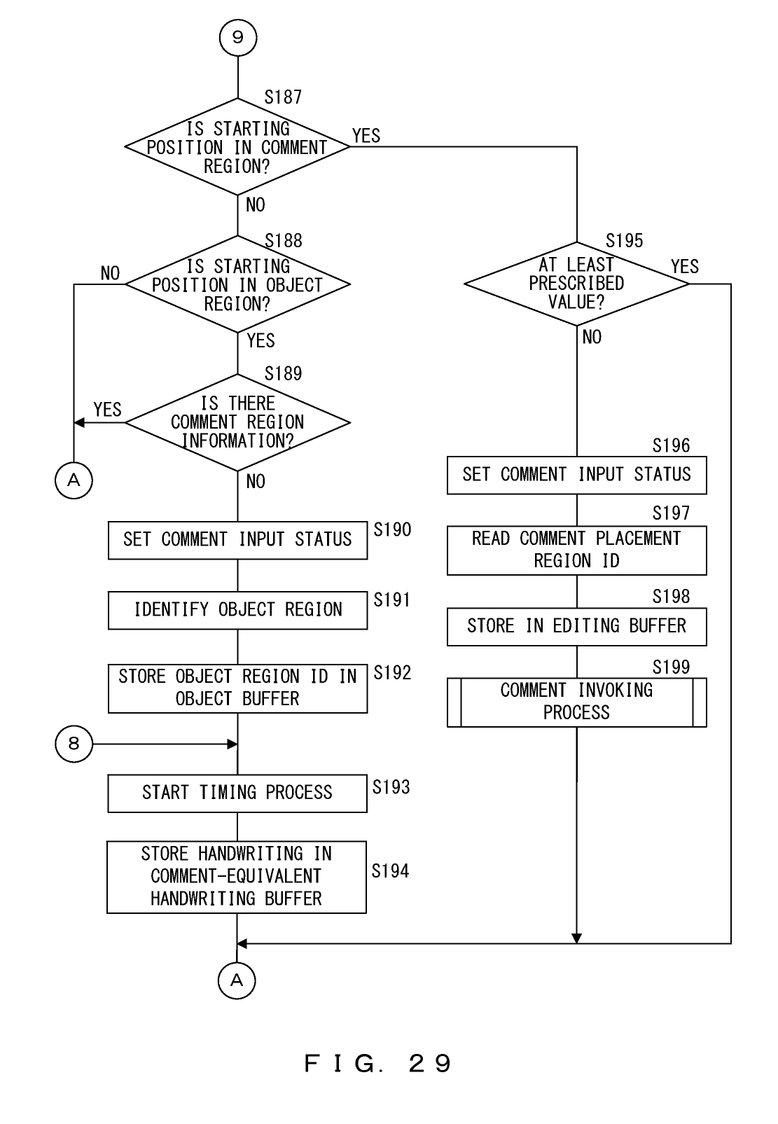

Next, in the PC 100 of this Embodiment 7, processes executed by the controller 10 in a case where the user starts a handwriting input to an image where an image and frames surrounding respective object regions is described on the basis of flowcharts. FIGS. 28 and 29 are flowcharts illustrating procedures executed by the PC 100 of Embodiment 7. The following processes are executed by the controller 10 according to a control program stored in the ROM 11 or the storage 13 of the PC 100.

In the PC 100 of this Embodiment 7, processes insteps S181 to S186 in FIG. 28 are similar to those in steps S21 to S26 in FIGS. 8 and 9 described in the aforementioned Embodiment 1.

If the controller 10 determines that the comment input status is set (S186: YES), the controller 10 advances the process to step S193. If the controller 10 determines that the comment input status is not set (S186: NO), the controller 10 determines whether the starting position of the input first stroke of handwriting is included in any one of the comment regions indicated by the comment region information stored in the detection region table 13a (S187).

If the controller 10 determines that the starting position of the input first stroke of handwriting is not included in any one of the comment regions (S187: NO), the controller 10 further determines whether or not the starting position of the first stroke of handwriting is included in any one of the object regions indicated by the object region information stored in the detection region table 13a (S188). If the controller 10 determines that the starting position of the first stroke is included in any one of the object regions (S188: YES), the controller 10 identifies which object region the position is included in and then determines whether or not the comment region information corresponding to the identified object region is stored in the detection region table 13a (S189).

If the controller 10 determines that the starting position of the first stroke of handwriting is not included in anyone of the object regions (S188: NO) or that there is comment region information corresponding to the object region including the starting position of the first stroke of handwriting (S189: YES), the controller 10 returns the process to step S182. Processes in steps S190 to S194 executed by the controller 10 in a case where the controller 10 determines that there is no comment region information corresponding to the object region including the starting position of the first stroke of handwriting (S189: NO) are similar to those in steps S28 to S32 in FIG. 9 described in the aforementioned Embodiment 1.

If the controller 10 determines in step S187, that the starting position of the first stroke of handwriting input is included in any one of the comment regions (S187: YES), the controller 10 determines whether the first stroke of handwriting has at least the prescribed value or not (S195). If the controller 10 determines that the first stroke of handwriting has at least the prescribed value (S195: YES), the controller 10 advances the process to step S182.

If the controller 10 determines that the first stroke of handwriting is shorter than the prescribed value (S195: NO), the controller 10 determines that the started handwriting input is an instruction of editing the comment information displayed in the comment region including the starting position of the first stroke of handwriting. The controller 10 sets the comment input status (S196).

The controller 10 identifies which comment region the starting position of the first stroke of handwriting is included in, and reads the comment placement region ID corresponding to the identified comment region from the detection region table 13a (S197). The controller 10 stores the read comment placement region ID in the editing buffer (S198). The controller 10 executes the comment invoking process (S199), and returns the process to step S182 after executing the comment invoking process. The details of the comment invoking process will be described later.

If the controller 10 determines in step S182, that the next one stroke of handwriting is not input via handwriting by the user (S182: NO), the controller 10 determines whether or not the comment input status is set or not at this time (S200). If the controller 10 determines that the comment input status is set (S200: YES), the controller 10 determines whether the prescribed time has elapsed or not on the basis of the result of the timing process started in step S193 (S201).

If the controller 10 determines that the comment input status is not set (S200: NO) or that the prescribed time has not elapsed yet (S201: NO), the controller 10 returns the process to step S182. If the controller 10 determines that the prescribed time has elapsed (S201: YES), the controller 10 determines that the user has finished the comment input, executes the comment process (S202) and, after executing the comment process, returns the process to step S181. The details of the comment process of this Embodiment 7 will be described later.

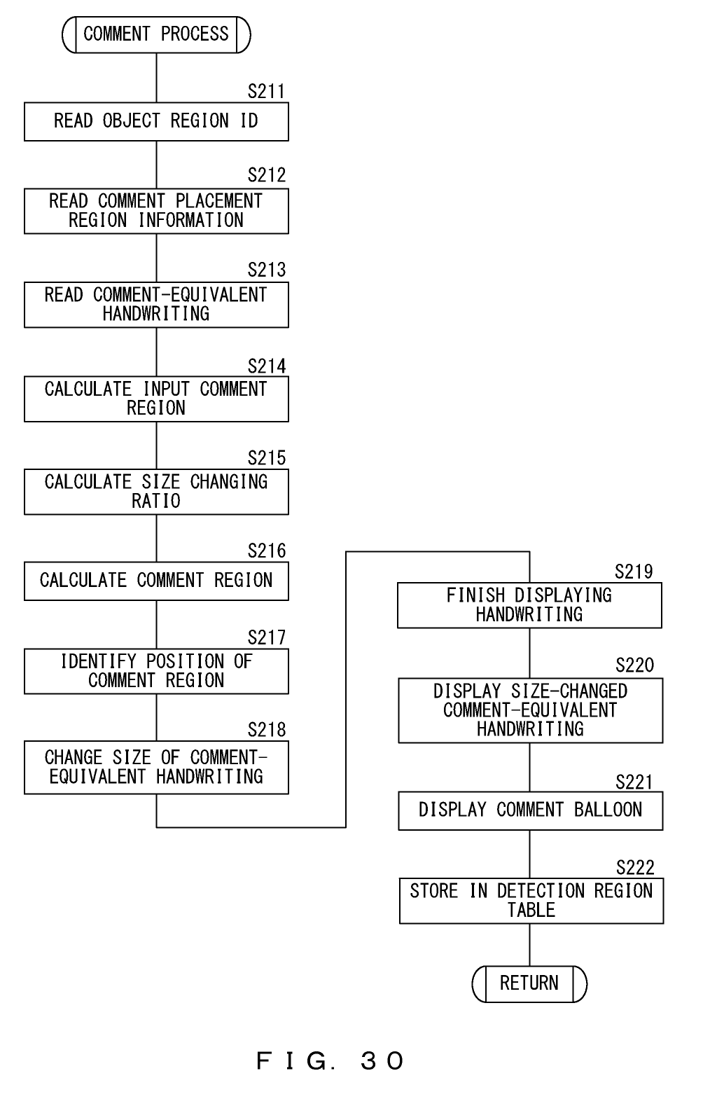

Next, the comment process (process in step S202 in FIG. 28) in the PC 100 of this Embodiment 7 will be described on the basis of a flowchart. FIG. 30 is a flowchart illustrating procedures of the comment process of Embodiment 7. The following processes are executed by the controller 10 according to a control program stored in the ROM 11 or the storage 13 of the PC 100.

The processes in steps S211 to S221 in FIG. 30 in the PC 100 of this Embodiment 7 are similar to those in steps S41 to S51 in FIG. 10 described in the aforementioned Embodiment 1.

The controller 10 stores information generated in the processes in steps S211 to S221 in the detection region table 13a (S222). More specifically, the controller 10 stores the comment region information indicating the comment region at a position identified in step S217 in the detection region table 13a. The controller 10 also stores the comment-equivalent handwriting, having been changed in size in step S218, as displayed handwriting information, and the comment-equivalent handwriting read in step S213 as the input handwriting information, in the detection region table 13a. The controller 10 finishes the aforementioned comment process, and returns the process to that illustrated in FIG. 28.

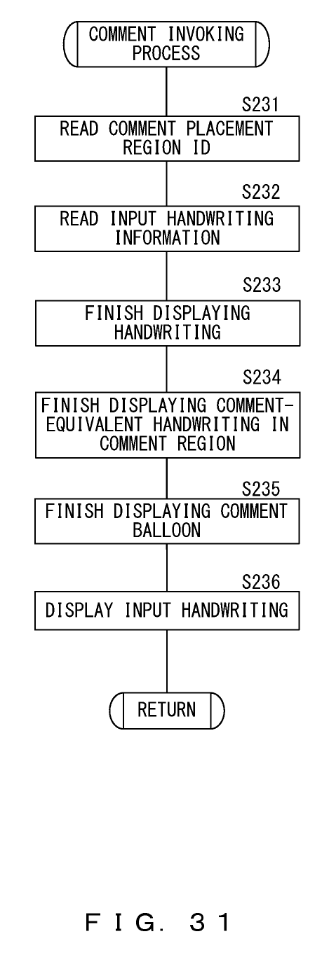

Next, the comment invoking process (process in step S199 in FIG. 29) in the PC 100 of this Embodiment 7 will be described on the basis of a flowchart. FIG. 31 is a flowchart illustrating procedures of the comment invoking process of Embodiment 7. The following processes are executed by the controller 10 according to a control program stored in the ROM 11 or the storage 13 of the PC 100.

The controller 10 reads the comment placement region ID stored in the editing buffer (S231). The controller 10 reads the input handwriting information corresponding to the read comment placement region ID from the detection region table 13a (S232). The controller 10 finishes displaying the handwriting displayed in step S184 in FIG. 28 (S233). The controller 10 reads the displayed handwriting information corresponding to the read comment placement region ID from the detection region table 13a, and finishes the display of the handwriting based on the displayed handwriting information, that is, the display of the comment information (comment-equivalent handwriting after size change) in the comment region (S234).

The controller 10 finishes displaying the comment balloon surrounding the comment information whose display has been finished in step S234 (S235). The controller 10 displays the handwriting (comment-equivalent handwriting) input by the user via handwriting on the image displayed on the display unit 14 on the basis of the input handwriting information read in step S232 (S236). The controller 10 finishes the aforementioned comment invoking process, and returns the process to that illustrated in FIG. 29.

In a case where the comment information (comment-equivalent handwriting) having previously been input via handwriting is displayed in the size and position as of the handwriting input, the displayed comment information may be edited.

As described above, the PC 100 of this Embodiment 7 thus starts a handwriting input at a desired position in the image displayed on the display unit 14, thereby allowing designation of whether the input is a comment input to a desired object (person) or a drawing operation at a desired position. In the PC 100 of this Embodiment 7, starting the handwriting input at a desired position in the image displayed on the display unit 14 further allows designation of whether or not the input is an instruction of editing the comment having already been added to the desired object. Accordingly, this Embodiment 7 allows not only addition of any piece of comment information to each object in the image, but also editing of the comment information having already been added.

In a case where a handwriting input is started in the comment region in the image, the PC 100 of this Embodiment 7 determines that an instruction of changing the comment information displayed on the comment region is issued. However, instead of such a configuration, a prescribed input operation, such as an input of a plurality of points to the comment region including the comment information that the user wishes to change, may be performed.

This Embodiment 7 has been described as a variation of the aforementioned Embodiment 1. However, Embodiment 7 is applicable to the configurations of the aforementioned Embodiments 2 to 6.

### Embodiment 8

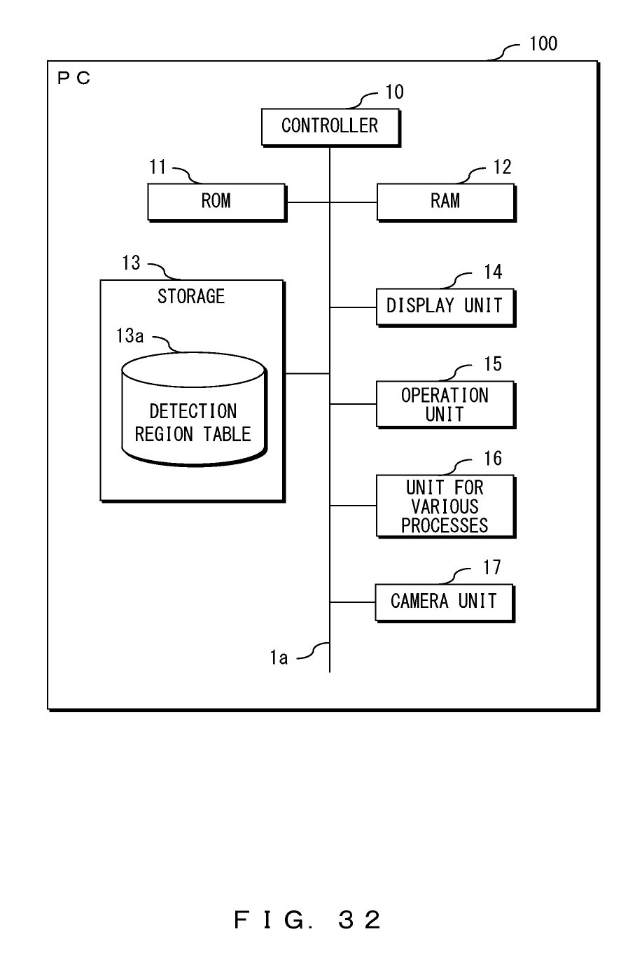

A PC according to Embodiment 8 will hereinafter be described. FIG. 32 is a block diagram of an example of a configuration of the PC of Embodiment 8. The PC 100 of this Embodiment 8 includes a camera unit (imaging unit) 17 in addition to the hardware units illustrated in FIG. 1. The camera unit 17 includes, for instance, an imaging unit including a CCD (Charge Couple Device), and an A/D (analog/digital) converter that converts an analog image frame acquired from the imaging unit into a digital image frame. The camera unit 17 acquires still image data or moving image data including 30 digital frames a second, and stores the data in the RAM 12 or the storage 13.

Accordingly, the PC 100 of this Embodiment 8 may apply a process analogous to that described in each of the aforementioned Embodiments to the image data acquired by imaging at the camera unit 17.

### Embodiment 9

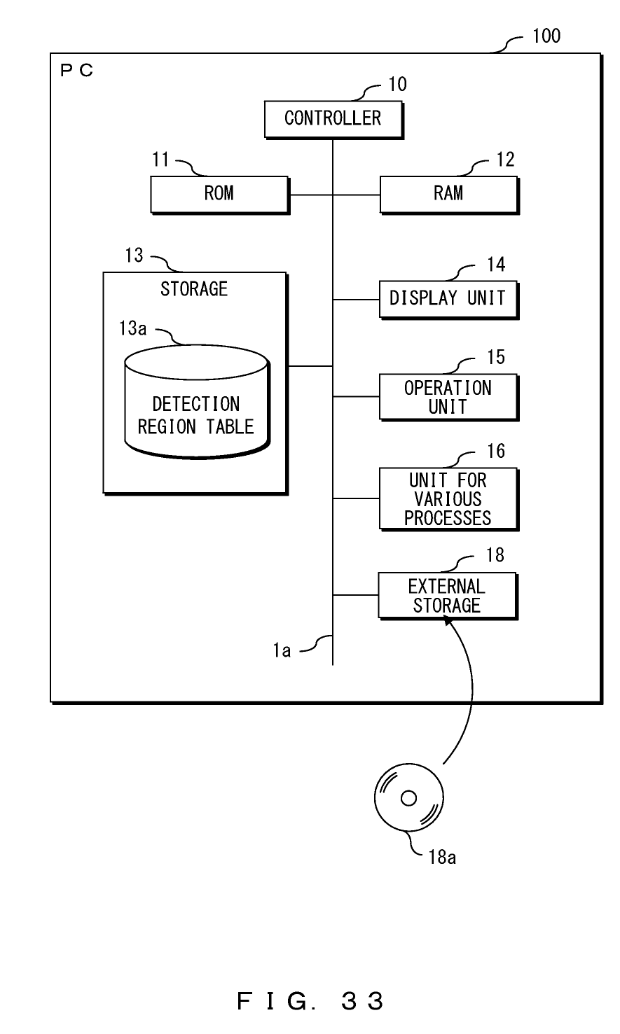

A PC according to Embodiment 9 will hereinafter be described. FIG. 33 is a block diagram illustrating an example of a configuration of the PC of Embodiment 9. The PC 100 of this Embodiment 9 includes an external storage 18 in addition to the hardware units illustrated in FIG. 1. The external storage 18 may be, for instance, a CD-ROM driver, a DVD driver or the like, and reads data stored in a recording medium 18a, which is a CD-ROM, DVD-ROM or the like.

The recording medium 18a records control programs used for operating as the PC 100 described in each of the aforementioned Embodiments. The external storage 18 reads the control programs from the recording medium 18a and stores the programs in the storage 13. The controller 10 reads the control programs stored in the storage 13 into the RAM 12 and sequentially executes the programs. This allows the PC 100 of this Embodiment 9 to execute an operation analogous to that of the PC 100 described in each of the aforementioned Embodiments.

Instead of the CD-ROM or the DVD-ROM, various recording media, such as a flexible disk, a memory card, a USB (Universal Serial Bus) memory and the like, may be adopted as the recording medium 18a.

The PC 100 may include a communication unit for connection to a network, such as the Internet and a LAN (Local Area Network). In this case, the PC 100 may download via the network the control programs, which is used for operation as the PC 100 described in each of the aforementioned Embodiments, and store the programs in the storage 13.

In each of the aforementioned Embodiments, in a case of detecting a prescribed object region in the image, a comment placement region corresponding to the detected object region is detected and the detected information is stored in the detection region table 13a. Instead of such a configuration, for instance, only an object region may be detected at the time the image data is read and, in a case where the user starts a handwriting input in any one of the object regions, a process of detecting a comment placement region corresponding to the object region may be started. In this case, the comment determination regions corresponding to the respective object regions are detected in the order of handwriting input by the user. This allows a previously input comment to the object to be preferentially displayed in a wide region.

As described above, the user performs a handwriting input at an appropriate position in the image. Accordingly, it may be designated which object the input information as a comment is directed to, and a desired comment may be input. This allows the user to add a comment to an appropriate region in the image without any operation other than a handwriting input of a comment to an appropriate position in the image. Therefore, an operation by the user when adding a comment to an object in the image may be simplified, thereby improving operability. Further, according to a position at which the user performs a handwriting input, it is detected whether the input information is a comment input that is to be added to the image or not. This allows the user to perform an input of a drawing and the like to an image by means of an analogous handwriting input operation in addition to an input of a comment to an object in the image.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An image display apparatus comprising:
an image display unit to display an image on a screen;
a handwriting acceptance unit to accept handwriting input to the image;
a handwriting display unit to display the handwriting on the image;
a detection unit to detect one or more object regions including respective one or more certain objects included in the image;
an object region display unit to display information indicating the object region on the image;
a determination unit to determine whether the handwriting is directed to any one of the object regions or not on the basis of the handwriting and the object region;
an object identification unit that, in a case where the determination unit determines that the handwriting is directed to any one of the object regions, identifies an identified region being the object region to which the handwriting is directed;
a placement region identification unit to identify a placement region for placing the handwriting to the identified region;
a calculator to calculate a scaling ratio in a scaling process executed on the handwriting for displaying the handwriting in the placement region;
a scaling unit to execute the scaling process on the handwriting according to the scaling ratio;
a display region extraction unit to extract a display region for displaying handwriting after the scaling process from the placement region; and
a scaled handwriting display unit to display the handwriting after the scaling process in the display region.

2. The image display apparatus according to claim 1, further comprising:
a placement region detector to detect a candidate region in which handwriting to the object region is placed; and
a storing unit to associate the candidate region with the object region and to store the associated regions,
wherein the placement region identification unit selects the placement region from among the candidate regions when the identified region is identified.

3. The image display apparatus according to claim 1, further comprising an association display unit to display a symbol for associating the handwriting displayed by the scaled handwriting display unit and the identified region with each other on the image.

4. The image display apparatus according to claim 1, wherein the detection unit detects a region including a face included in the image.

5. The image display apparatus according to claim 1,
wherein the determination unit determines whether the handwriting is handwriting to any one of the object regions or not on the basis of whether a starting position of a first stroke of handwriting accepted by the handwriting acceptance unit is in any one of the object regions or not, and
the object identification unit identifies that the handwriting is directed to the object region that is determined by the determination unit to include the starting position of the first stroke of the handwriting.

6. The image display apparatus according to claim 5, further comprising
a determination region display unit to regard a prescribed extent in each object region as a determination region and to display information indicating the determination region,
wherein the determination unit determines whether the handwriting is directed to anyone of the object regions or not on the basis of whether the starting position of the first stroke of handwriting accepted by the handwriting acceptance unit is in the determination region or not.

7. The image display apparatus according to claim 1, further comprising:
a discrimination unit that, in a case where the determination unit determines that the handwriting is directed to any one of the object regions, discriminates whether the first stroke of the handwriting accepted by the handwriting acceptance unit has a prescribed length or not;
a determination region display unit that, in a case where the discrimination unit discriminates that the first stroke of the handwriting has at least the prescribed length, displays information indicating a prescribed determination region at a finishing position of the first stroke of the handwriting; and
a monitoring unit that, in a case where the determination region display unit displays information indicating the prescribed determination region, monitors whether or not the handwriting acceptance unit accepts the handwriting whose input is started in the prescribed determination region,
wherein the handwriting acceptance unit, in a case of accepting the handwriting whose input is started in the prescribed determination region, accepts the handwriting whose input is started in the prescribed determination region as handwriting to the identified region.

8. The image display apparatus according to claim 7,
wherein the monitoring unit monitors whether or not the handwriting acceptance unit accepts the handwriting whose input is started in the prescribed determination region in a prescribed time after the determination region display unit displays the information indicating the prescribed determination region, and
the determination region display unit, in a case where the handwriting acceptance unit does not accept the handwriting whose input is started in the prescribed determination region in a prescribed time after displaying the information indicating the prescribed determination region, finishes displaying the information indicating the prescribed determination region.

9. The image display apparatus according to claim 1,
wherein the determination unit determines that the handwriting accepted by the handwriting acceptance unit is directed to any one of the object regions, and subsequently, in a case where the handwriting acceptance unit does not accept the handwriting for a prescribed time, determines that input of the handwriting is finished, and
the calculator, in a case where the determination unit determines that the input of the handwriting is finished, calculates the scaling ratio.

10. The image display apparatus according to claim 1, further comprising:
a character string recognition unit to execute character string recognition on the handwriting accepted by the handwriting acceptance unit; and
a character string determination unit for determining whether or not the handwriting is a character string on the basis of a result of the character string recognition,
wherein, in a case where the character string determination unit determines that the handwriting is a character string, the calculator calculates the scaling ratio.

11. The image display apparatus according to claim 1, further comprising:
a character string recognition unit to execute character string recognition on the handwriting accepted by the handwriting acceptance unit; and
a character string determination unit for determining whether the handwriting is a character string or not on the basis of a result of the character string recognition,
wherein, in a case where the character string determination unit determines that the handwriting is a character string, the display region extraction unit extracts a display region in which the character string recognized by the character string recognition unit is displayed from the placement region, and,
the scaled handwriting display unit displays the character string recognized by the character string recognition unit in the display region extracted by the display region extraction unit using prescribed font information.

12. The image display apparatus according to claim 1, further comprising:
a handwriting storing unit to associate the handwriting accepted by the handwriting acceptance unit and information indicating the placement region with each other and to store the associated handwriting and the information in association with the handwriting after the scaling process;
an operation discrimination unit to discriminate whether or not a prescribed operation is performed on the handwriting after the scaling process stored in the handwriting storing unit;
an input handwriting display unit that, in a case where the operation discrimination unit discriminates that the prescribed operation is performed, displays handwriting that is accepted by the handwriting acceptance unit and stored in the handwriting storing unit in association with the handwriting after the scaling process, on the image; and
a change acceptance unit to accept a change on the handwriting displayed by the input handwriting display unit,
wherein the handwriting acceptance unit accepts the handwriting after the change accepted by the change acceptance unit on the handwriting displayed by the input handwriting display unit,
the calculator calculates the scaling ratio in the scaling process that is executed on the changed handwriting for display in the placement region that is stored in the handwriting storing unit in association with the handwriting after the scaling process in which the operation discrimination unit discriminates that the handwriting after the change accepted by the handwriting acceptance unit has been subjected to a prescribed operation,
the scaling unit executes the scaling process on the changed handwriting according to the scaling ratio calculated by the calculator, and
the display region extraction unit extracts a display region in which the handwriting after the scaling process is displayed, from the placement region stored in the handwriting storing unit.

13. The image display apparatus according to claim 1, further comprising imaging unit to take an image.

14. An image display method including:
displaying an image on a display unit;
accepting handwriting input to the displayed image;
displaying the accepted handwriting on the image;
detecting one or more object regions including respective one or more prescribed objects included in the image;
displaying information indicating the detected object region on the image;
determining whether the handwriting is directed to any one of the detected object regions or not on the basis of the accepted handwriting and the detected object region;
identifying an identified region being the object region to which the handwriting is directed when the handwriting is directed to any one of the object regions;
identifying a placement region for placing the handwriting to the identified region;
calculating a scaling ratio in a scaling process executed on the handwriting for displaying the handwriting in the identified placement region;
executing the scaling process on the handwriting according to the calculated scaling ratio;
extracting a display region for displaying handwriting after the scaling process from the identified placement region; and
displaying the handwriting after the scaling process in the extracted display region.

15. A storing medium storing a computer program causing a computer to execute processes of:
displaying an image on a display unit,
accepting handwriting input to the displayed image,
displaying the accepted handwriting on the image,
detecting one or more object regions including respective one or more prescribed objects included in the image;
displaying information indicating the detected object region on the image;
determining whether the handwriting is directed to any one of the detected object regions or not on the basis of the accepted handwriting and the detected object region;
identifying an identified region being the object region to which the handwriting is directed when the handwriting is directed to any one of the object regions;
identifying a placement region for placing the handwriting to the identified region;
calculating a scaling ratio in a scaling process executed on the handwriting for displaying the handwriting in the identified placement region;
executing the scaling process on the handwriting according to the calculated scaling ratio;
extracting a display region for displaying handwriting after the scaling process from the identified placement region; and
displaying the handwriting after the scaling process in the extracted display region.
